(19) United States
(12) Patent Application Publication
(10) Pub. No.: US 2022/0058588 A1
(43) Pub. Date: Feb. 24, 2022

(54) Methods and Apparatus for Talent Assessment

(71) Applicant: Institute for Supply Management, Inc., Tempe, AZ (US)

(72) Inventors: Susan K. Marty, Sottsdale, AZ (US); Jessica A. Boyd, Gilbert, AZ (US)

(21) Appl. No.: 17/224,954

(22) Filed: Apr. 7, 2021

Related U.S. Application Data
(60) Provisional application No. 63/006,219, filed on Apr. 7, 2020.

(51) Int. Cl. G06Q 10/10; G06Q 10/06

(52) U.S. Cl. CPC G06Q 10/1053; G06Q 10/063112

(57) ABSTRACT

Methods and apparatus for talent assessment according to various aspects of the present technology may operate in conjunction with hardware and software to provide a talent assessment system, inclusive of technical, functional, business, and soft skill competencies. The talent assessment system and its supporting framework may include an automated process, deeper reporting, organization benchmarking of self-assessment results, as well as manager review and assessment to provide a multi-degree perspective. Assessments may feature right and wrong answers, as well as abstract reasoning.

### CROSS-REFERENCE TO RELATED APPLICATION

This application claims the benefit of U.S. Provisional Patent Application No. 63/006,219, filed Apr. 7, 2020, and incorporates the disclosure of that application by reference.

### BACKGROUND

Of the range of technical and soft skill competencies necessary to excel within the evolving field of supply management, nothing holistically addresses this gap in the market. Certain human resources technologies may offer different kinds of recruiting tests, including personality assessments and knowledge-based tests. But such technologies are not based on the functionality and purposes of the present platform, nor do they provide comparable outcomes.

Soft skills are a particular pain point for supply management leaders. Technical skills can be taught in training or on-the-job, yet strategic soft skills represent an untapped issue prevalent in today's corporate environment, both in mature and immature supply chain organizations.

### BRIEF DESCRIPTION OF THE DRAWING FIGURES

A more complete understanding of the present invention may be derived by referring to the detailed description and claims when considered in connection with the following illustrative figures. In the following figures, like reference numbers refer to similar elements and steps throughout the figures.

FIG. 1 is a conceptual drawing of an exemplary system for implementing methods and apparatus for assessing talent.

FIG. 2 is a drawing of a server in communication with a database.

FIG. 3 illustrates a “supply chain competency assessment—targets” interface.

FIGS. 4A-B illustrate a “supply chain competency assessment—custom data slicers” interface.

FIG. 5 illustrates a “supply chain competency assessment—settings” interface.

FIG. 6 illustrates a “supply chain competency assessment—communication” interface.

FIG. 7 illustrates a “supply chain competency assessment—summary” interface.

FIGS. 8A-D illustrate a “my company—people” interface.

FIGS. 9A-F illustrate a “my company—teams” interface.

FIG. 10 illustrates a “my company—company” interface.

FIG. 11 illustrates a conceptual implementation of an embodiment of the present system.

FIGS. 12A-E are a table of roles and groups.

FIG. 13 is a table of roles, descriptions, and positions.

FIGS. 14A-F illustrate a user assessment interface.

FIG. 15 illustrates a “results—history” interface.

FIGS. 16A-B illustrate a “results—assessment overview” interface.

FIGS. 17A-F are a table of roles, groups, and job roles.

FIGS. 18A-I are a table of a base list of roles and groups and a unique list of roles and groups.

FIGS. 19A-C illustrate a user assessment interface.

FIGS. 20A-C illustrate a user assessment interface.

FIGS. 21A-B illustrate a “results—assessment overview” interface.

FIGS. 22A-D illustrate a “dashboard” interface.

FIG. 23 illustrates a “my team” interface.

FIGS. 24A-B illustrate a “my teams” interface and sub-interface.

FIGS. 25A-B illustrate a “results—by assessment” interface.

FIGS. 26A-C illustrate a “company setup” interface.

FIGS. 27A-E illustrate an “assessments” interface and sub-interfaces.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

Various aspects of the present invention may be described in terms of functional block components and various processing steps. Such functional blocks may be realized by any number of hardware or software components configured to perform the specified functions and achieve the various results. For example, exemplary embodiments of the present invention may employ various servers, networks, storage systems, communications systems, algorithms, and the like, which may carry out a variety of functions. In addition, various aspects of the present technology may be practiced in conjunction with any number of fields of interest, and the systems and methods described are merely exemplary applications for the invention.

Various representative implementations of the present invention may be applied to any system for assessing talent. Methods and apparatus for assessing talent may operate in conjunction with a computer system, such as a remotely accessible computer system connected to a communications network. Various embodiments relate to an assessment system including a software platform for talent assessments. The software platform may host a suite of data, benchmarking, assessment models, machine learning, and automation elements. The software platform may similarly support other professions' assessments that assess competencies, inclusive of skills, knowledge, and mindset applicable to a profession or trade. Various levels of prevalence data and benchmarking may be generated over time. Data can be cut or otherwise processed or analyzed across similar organizations, within industry verticals, and the like, to support talent management decision-making within the profession, and in other areas such as human resources and talent identification and development.

The software platform features elements such as the platform structure, assessment capabilities, data uses, benchmarking, machine learning, job matching, development plans and reporting, as well as the contents of the skills-based assessments themselves. The software platform may offer talent assessment for a competitor's industry or area of practice for existing employees, along with the new hire match, data from the assessment tool and various ways to sort and review the data, and/or a database of professionals and the ability to match them with a job, recommendation for the employer, or for contingent workers. The software platform may also provide a community of practitioners by profession and industry, with the unique data of their actual skills based on the assessment, as opposed to the person self-selecting. The database of various professions, industries, competencies, roles, job descriptions and assessments, such as in one database, may facilitate the ability to leverage that data and report on it. The system may offer a complete database of all professions and the features described.

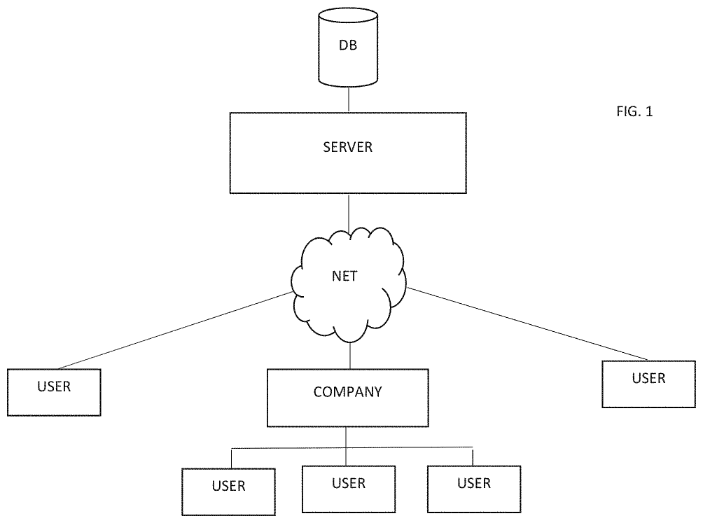

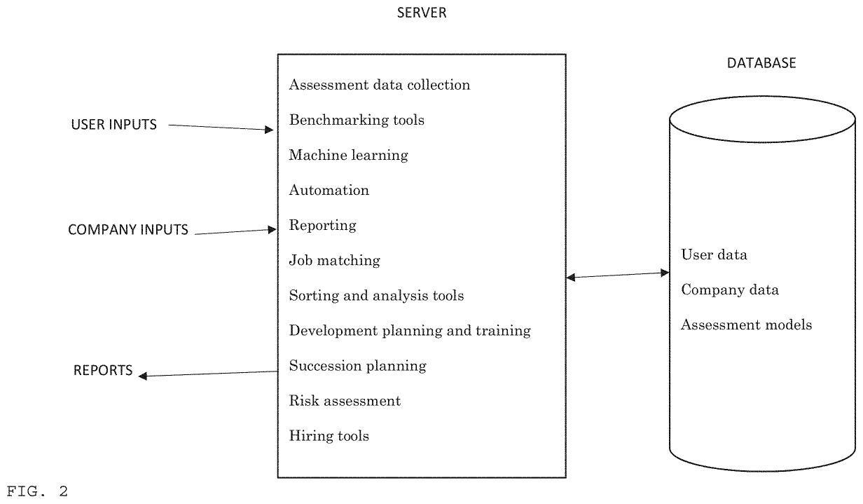

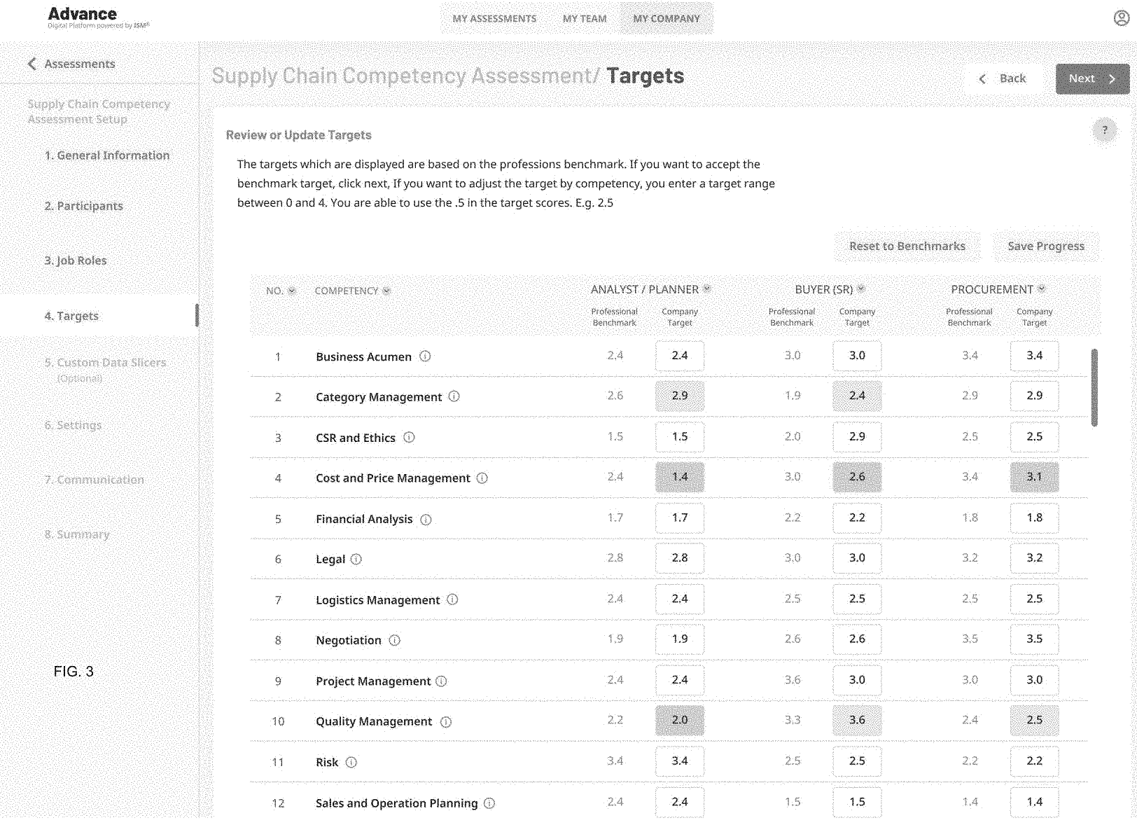

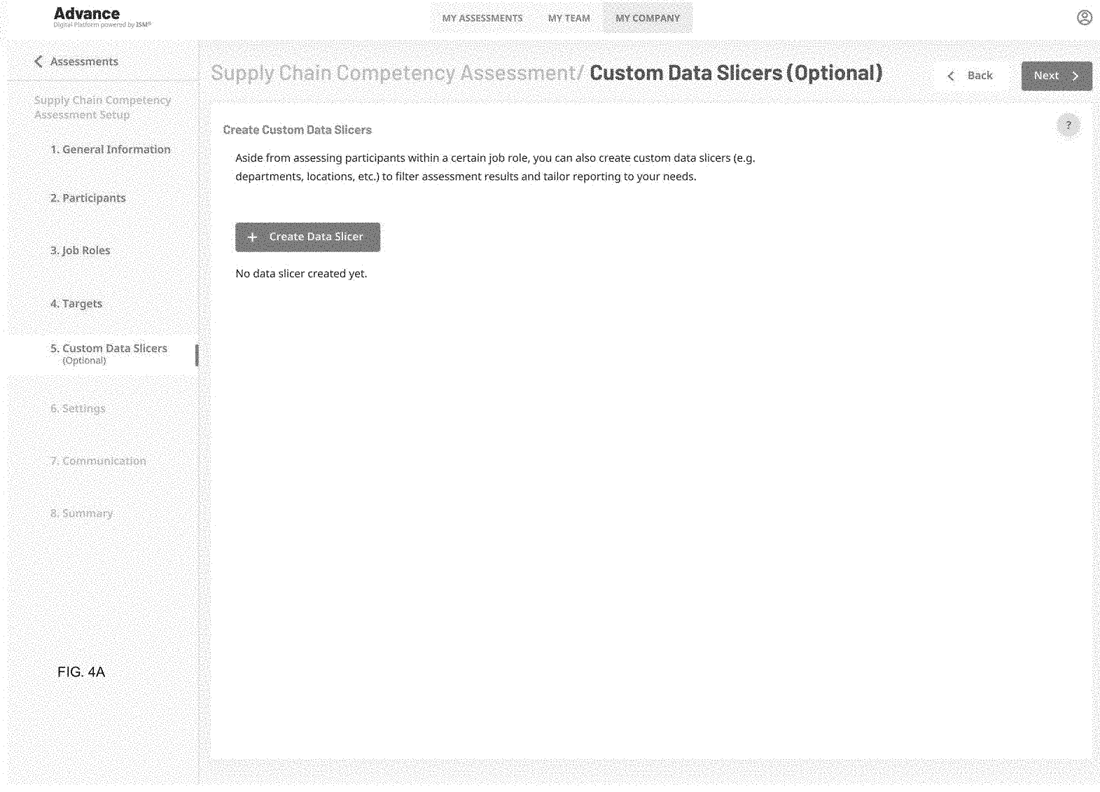

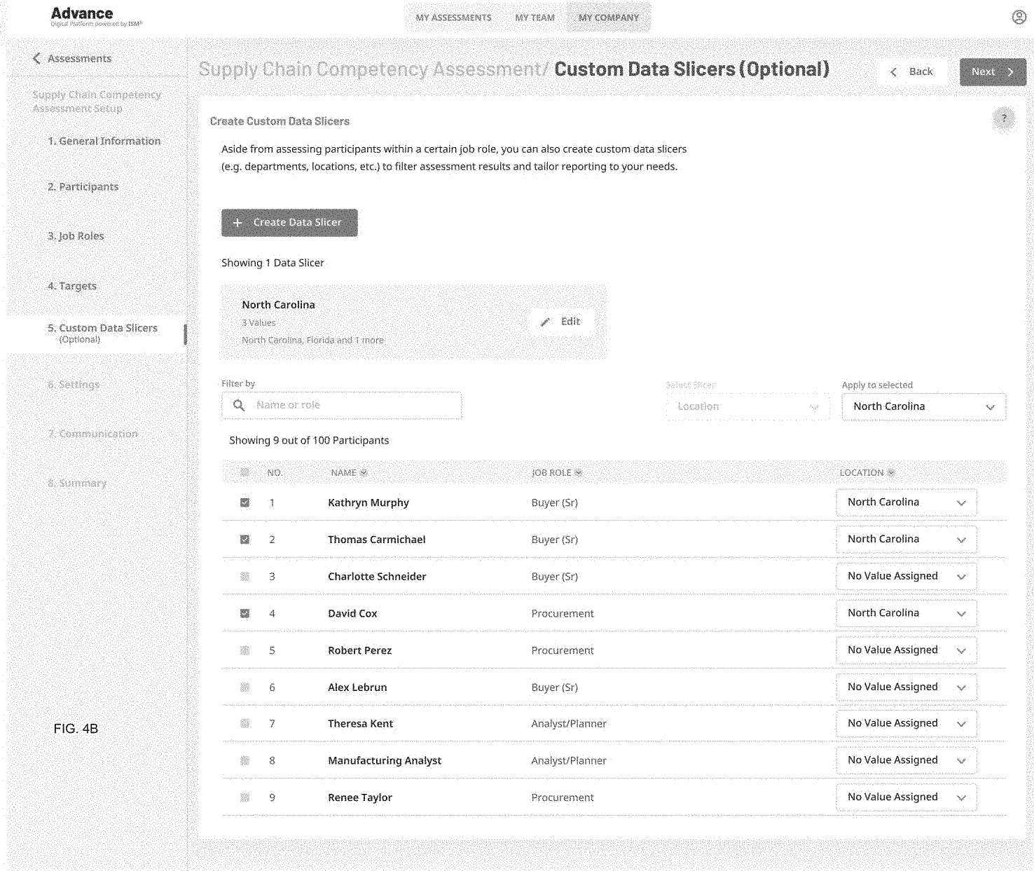

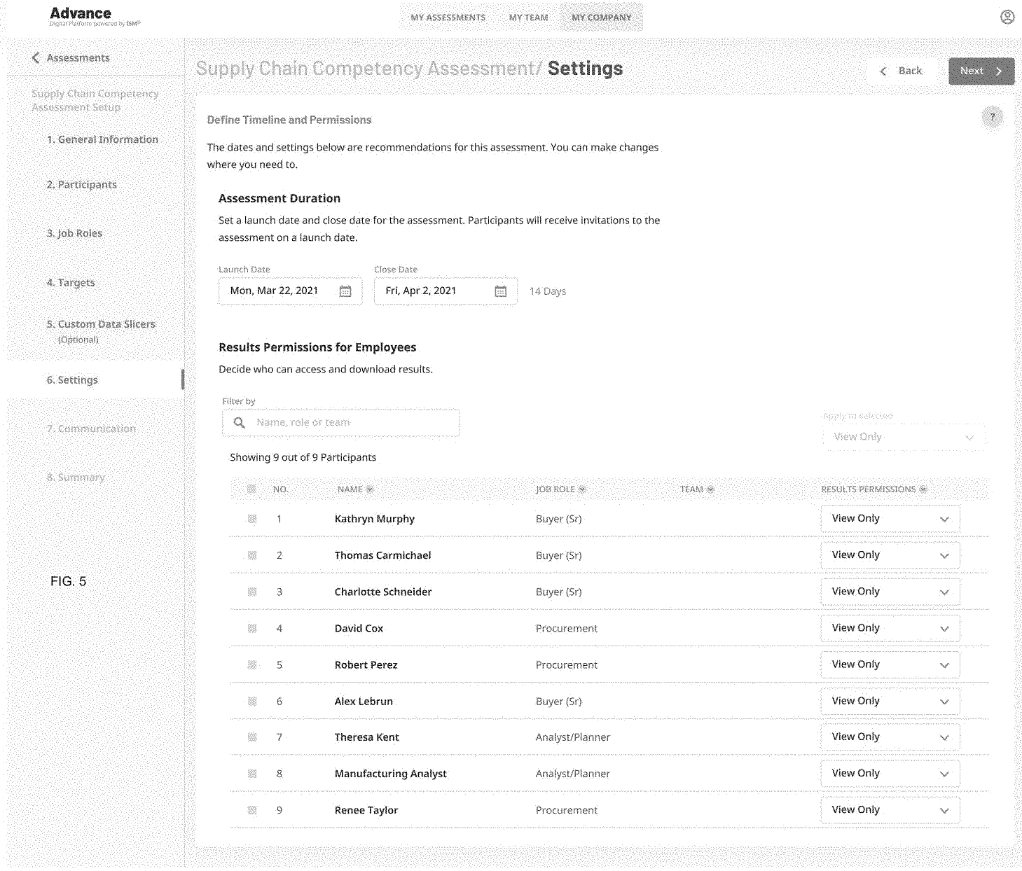

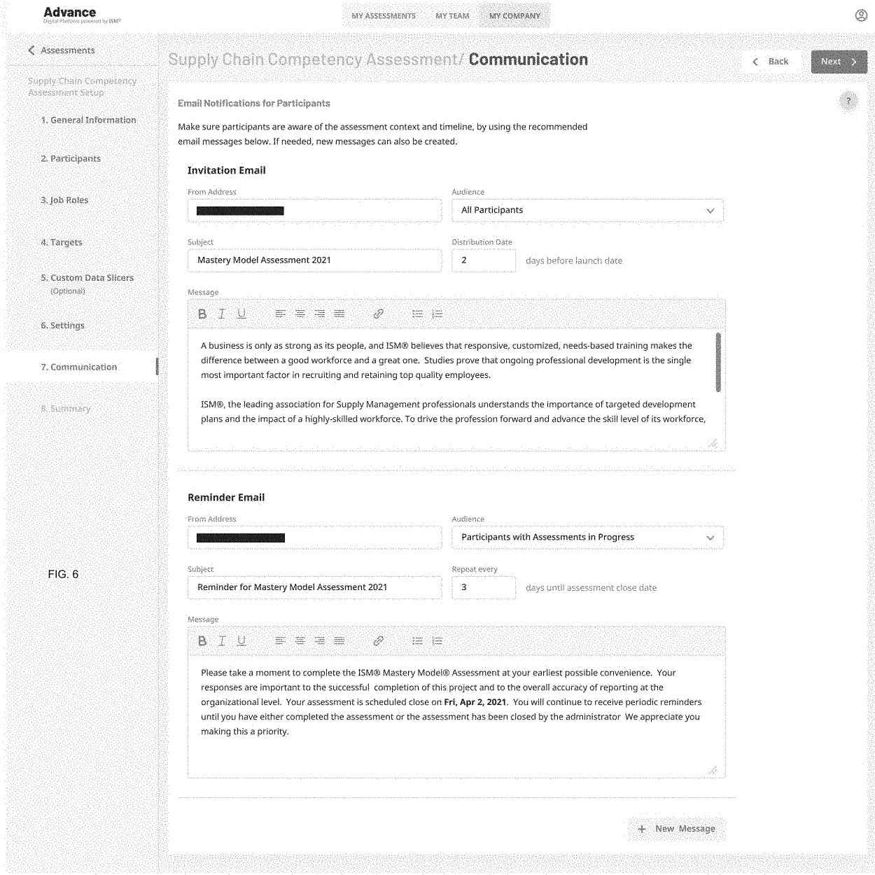

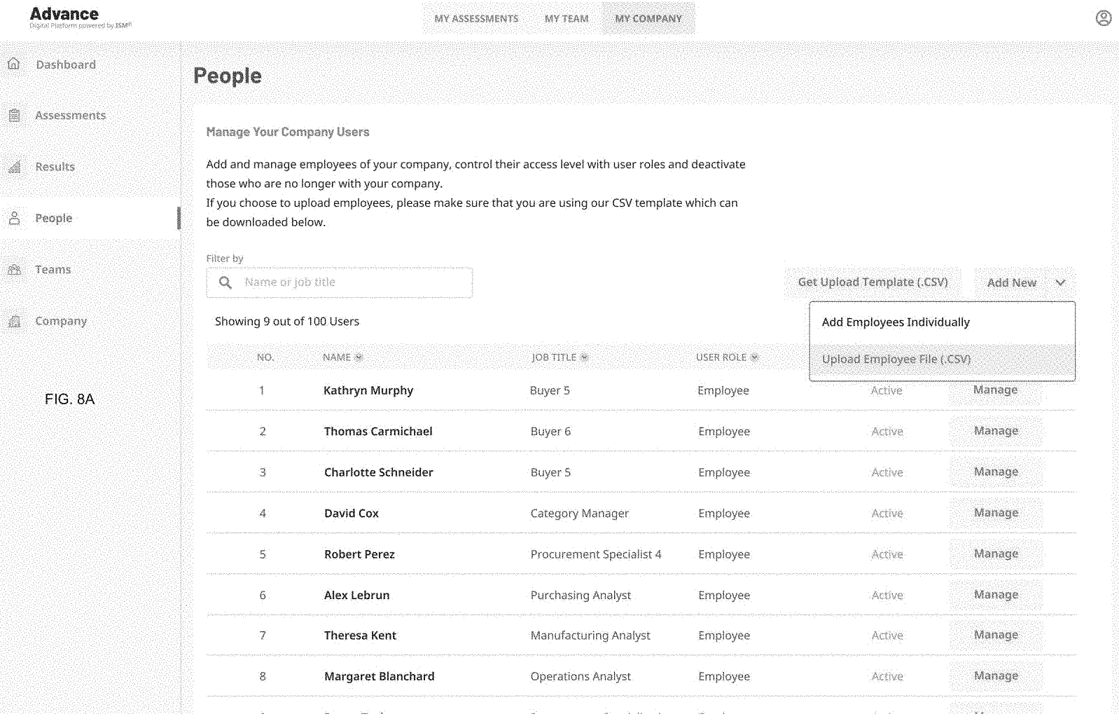

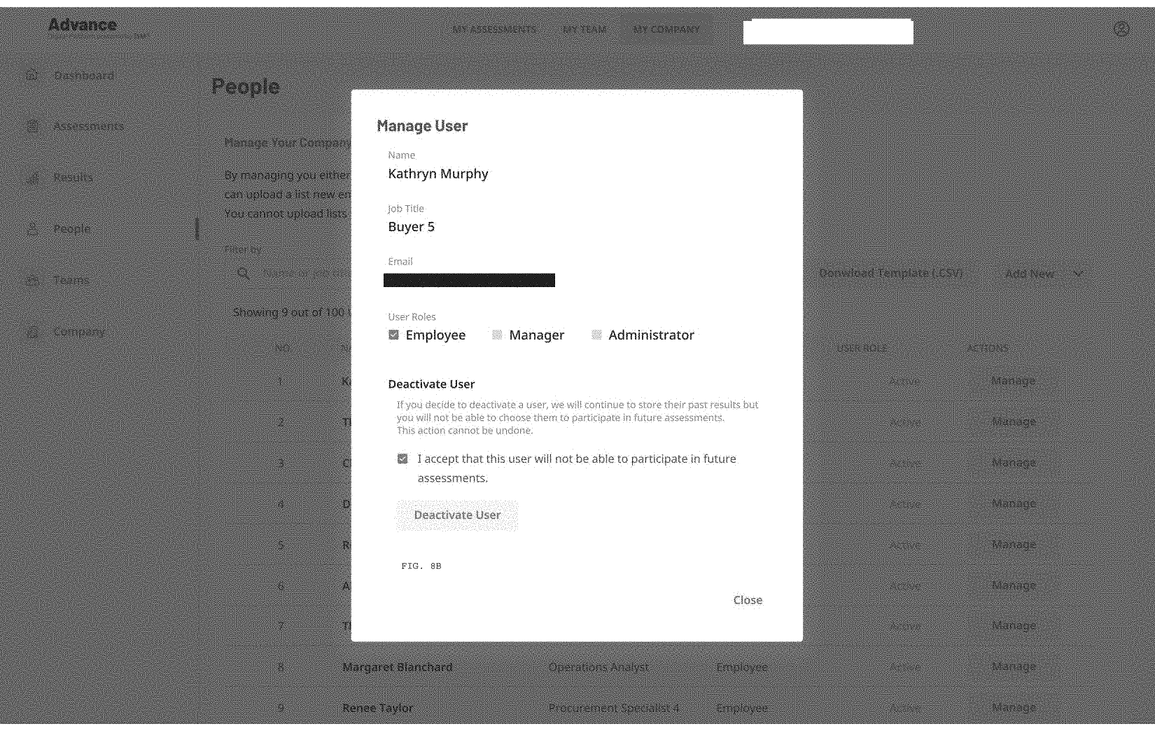

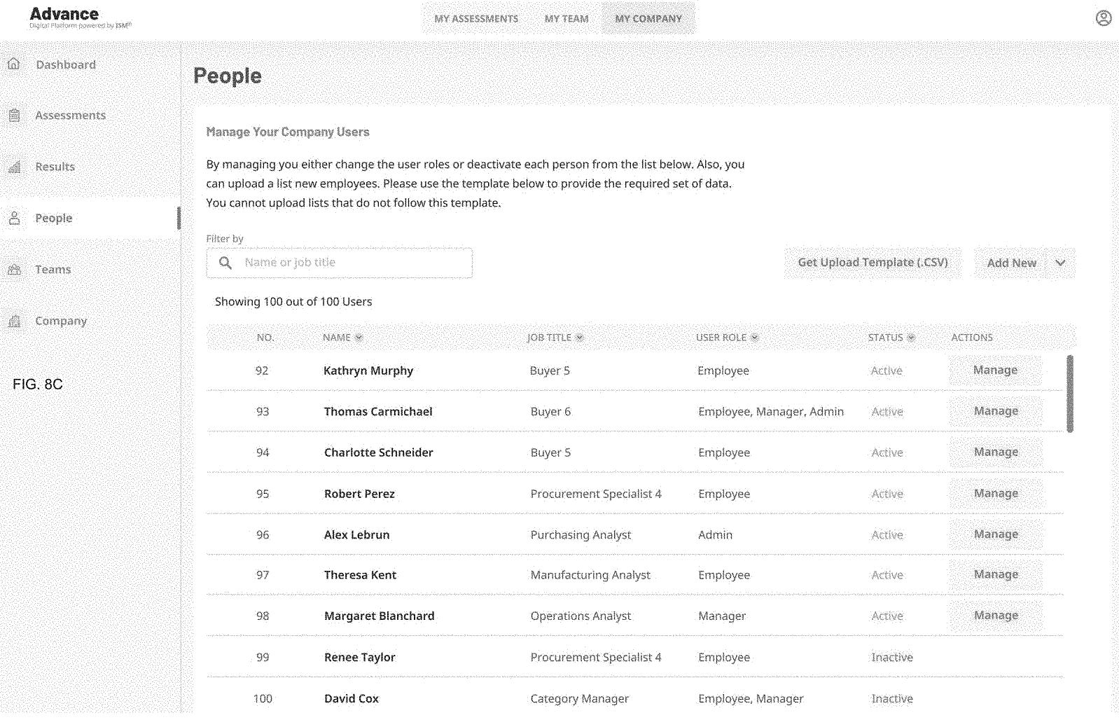

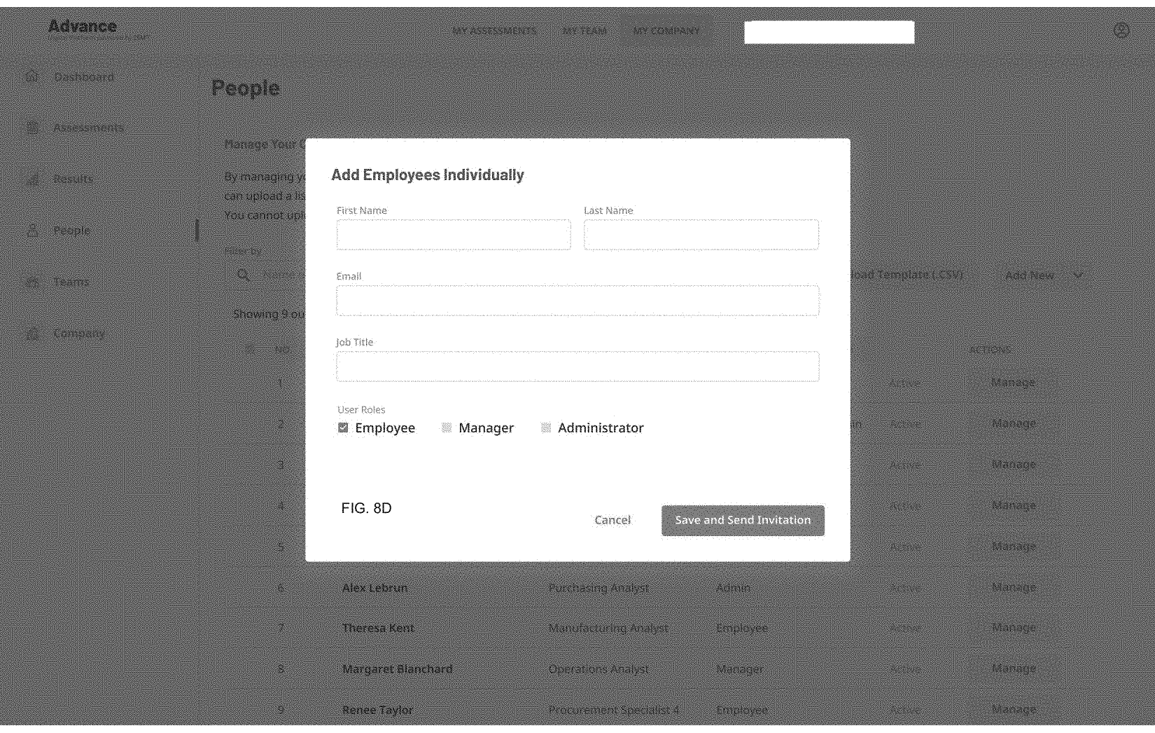

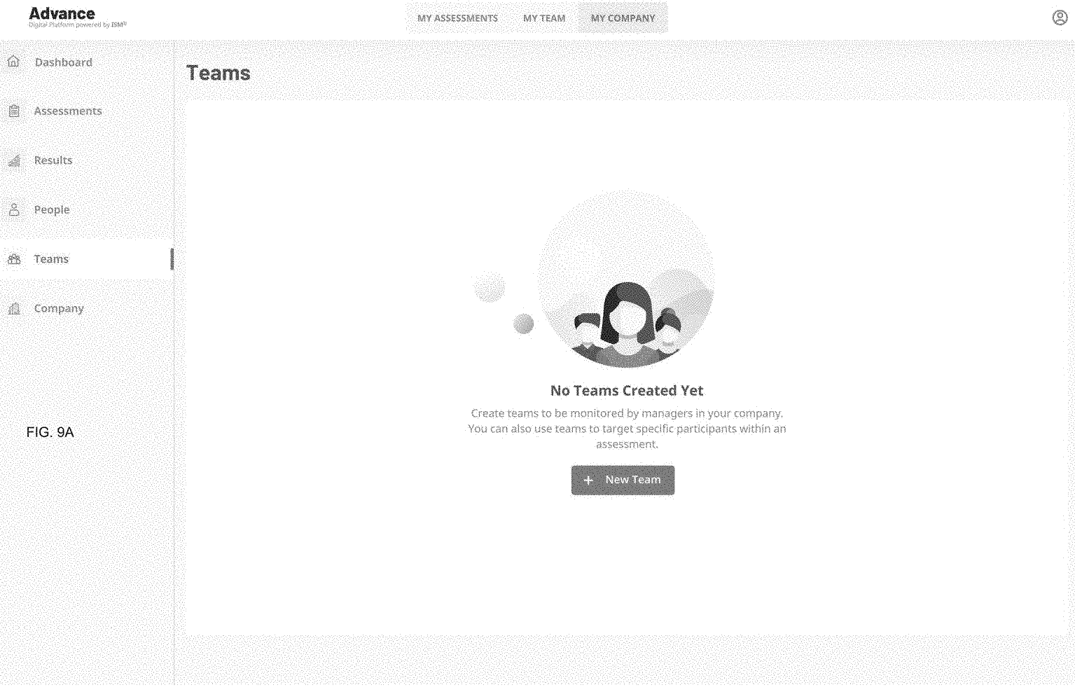

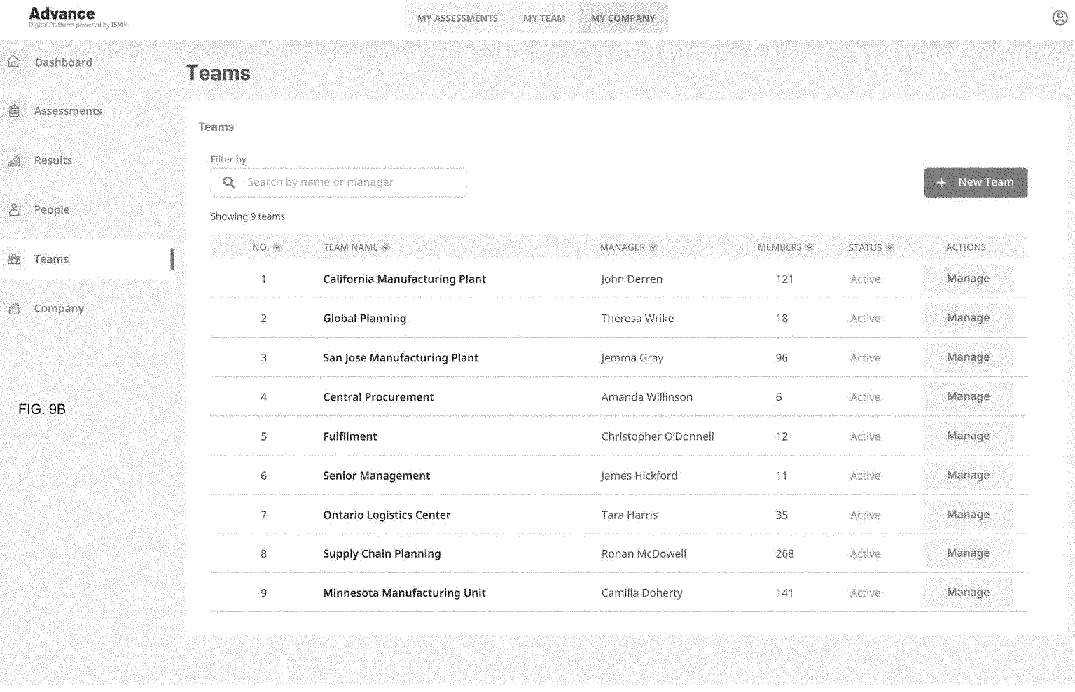

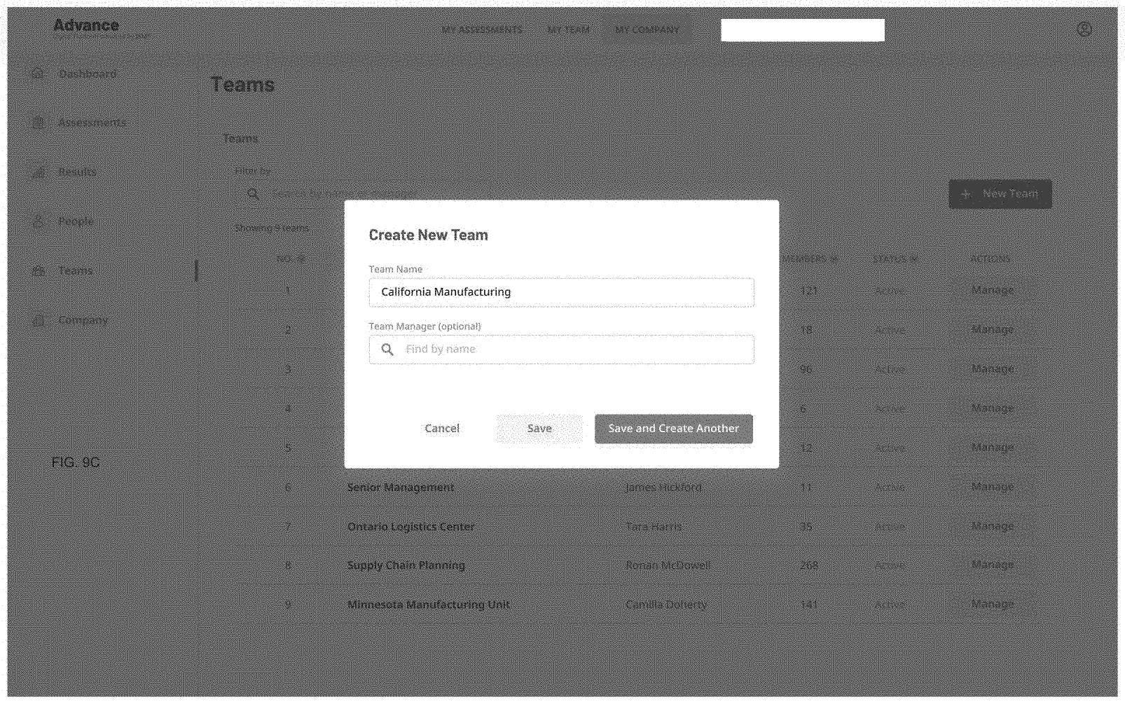

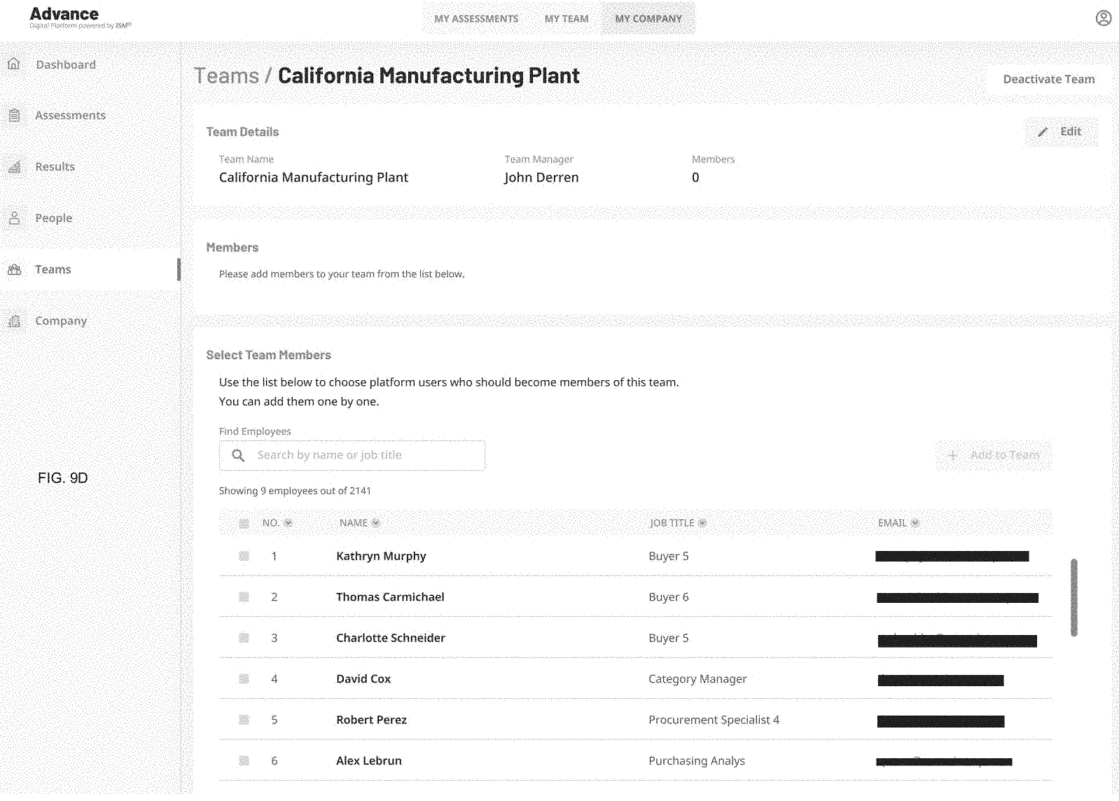

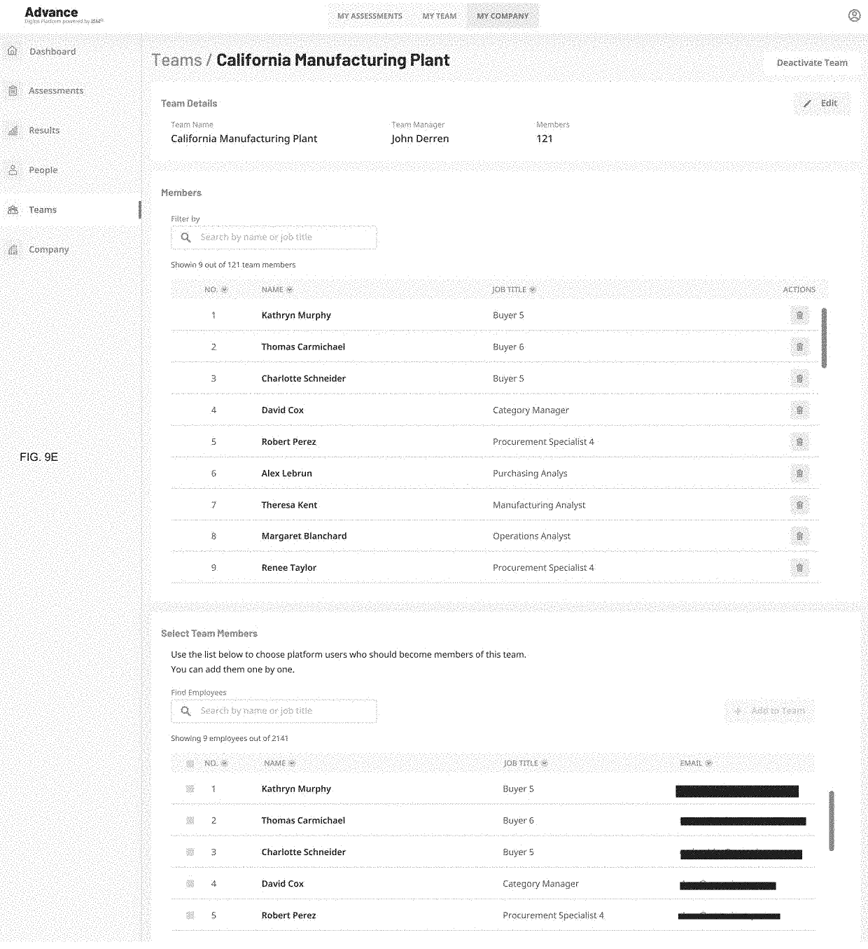

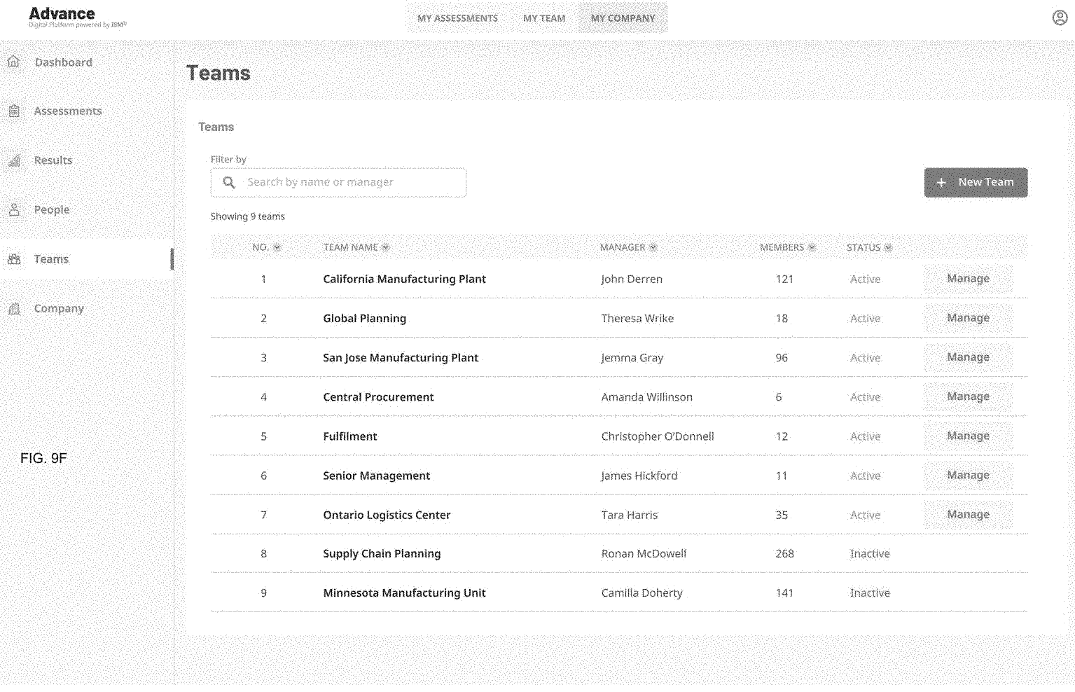

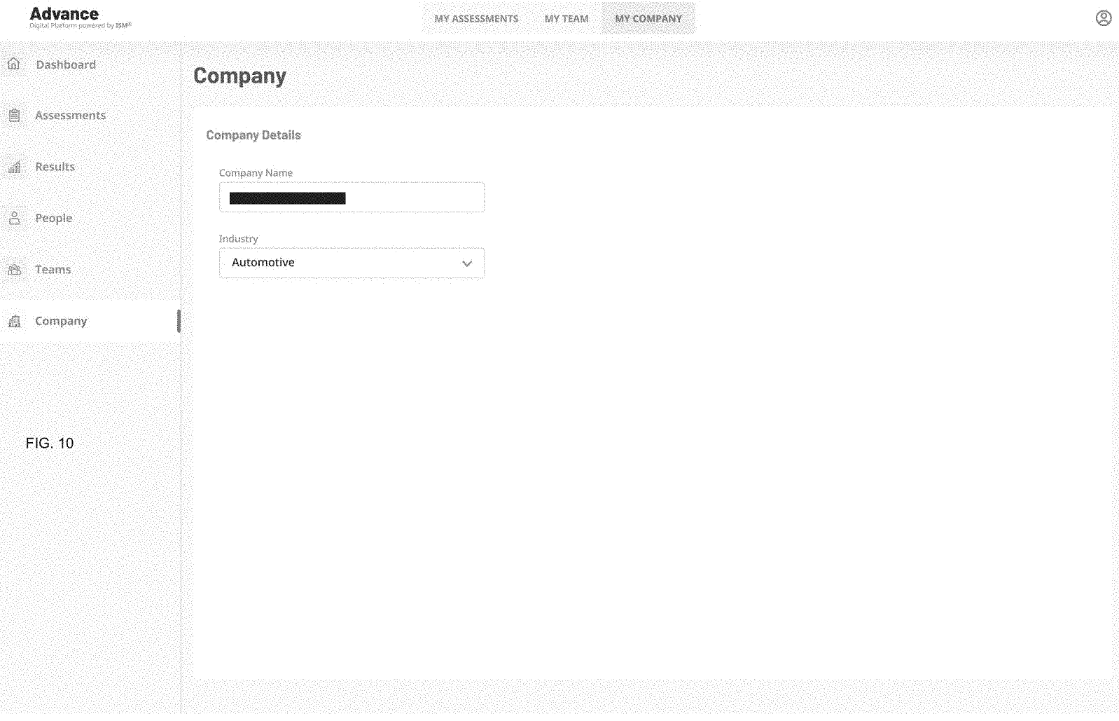

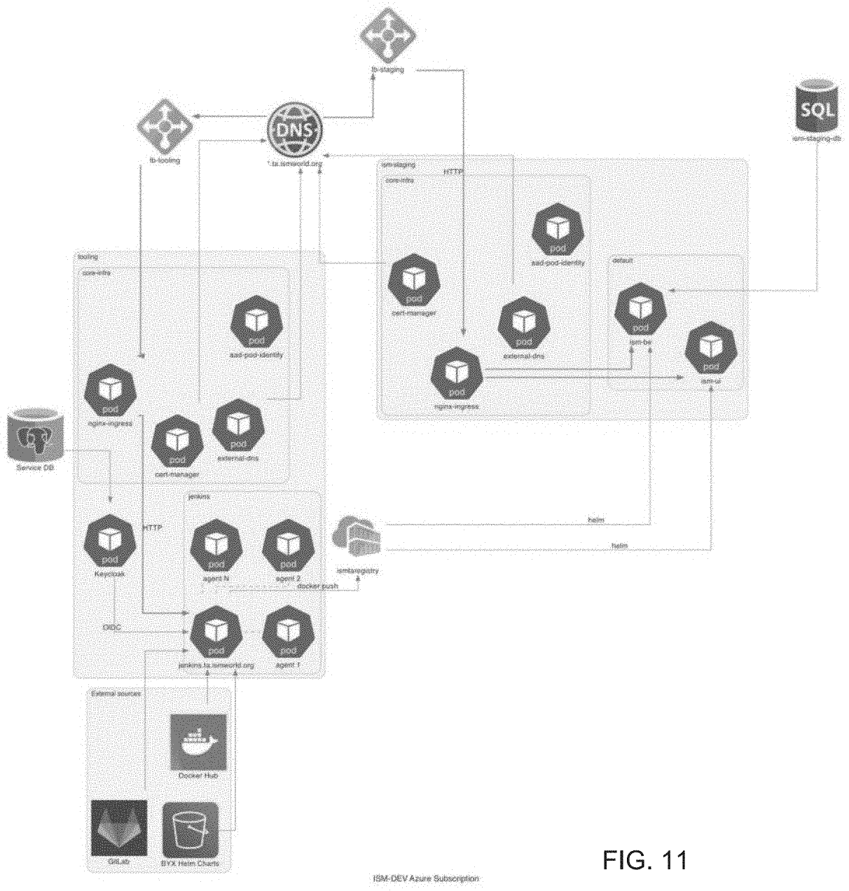

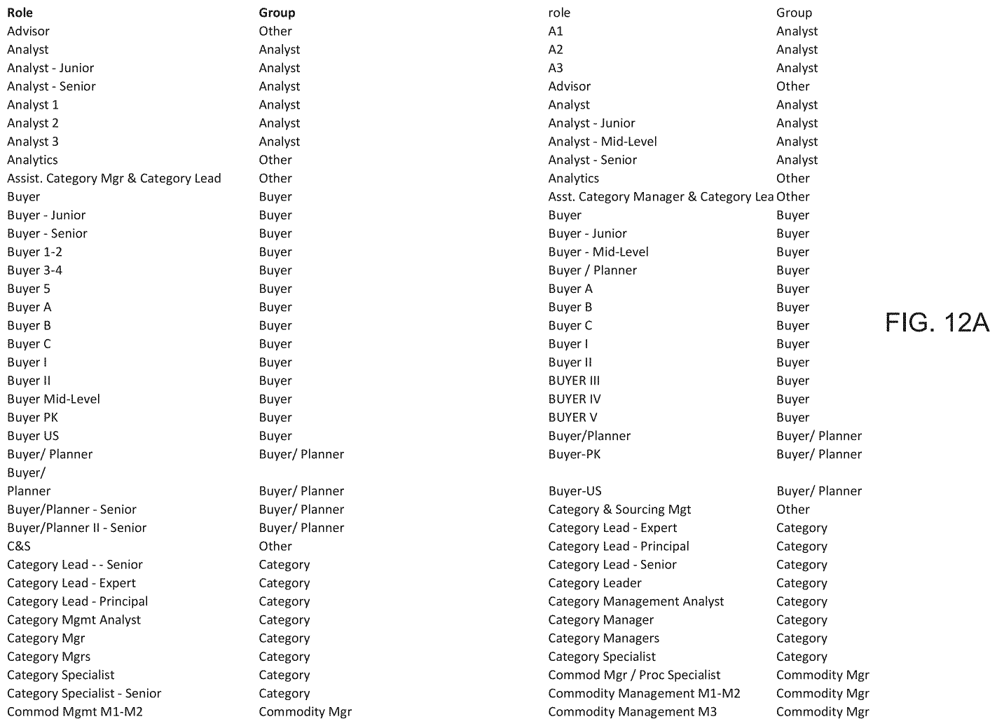

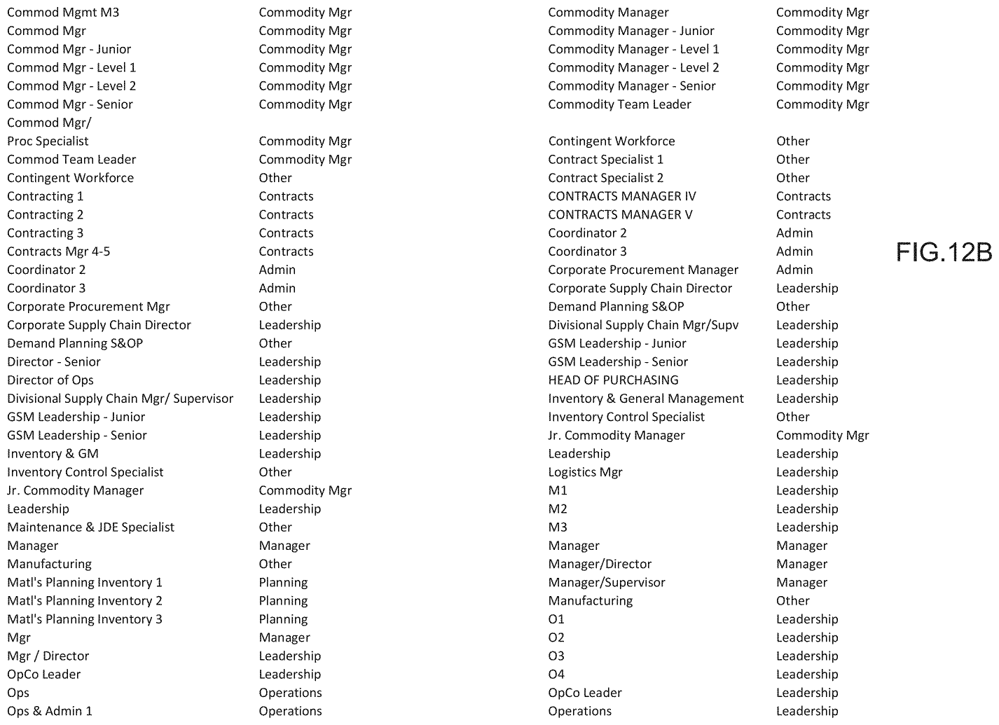

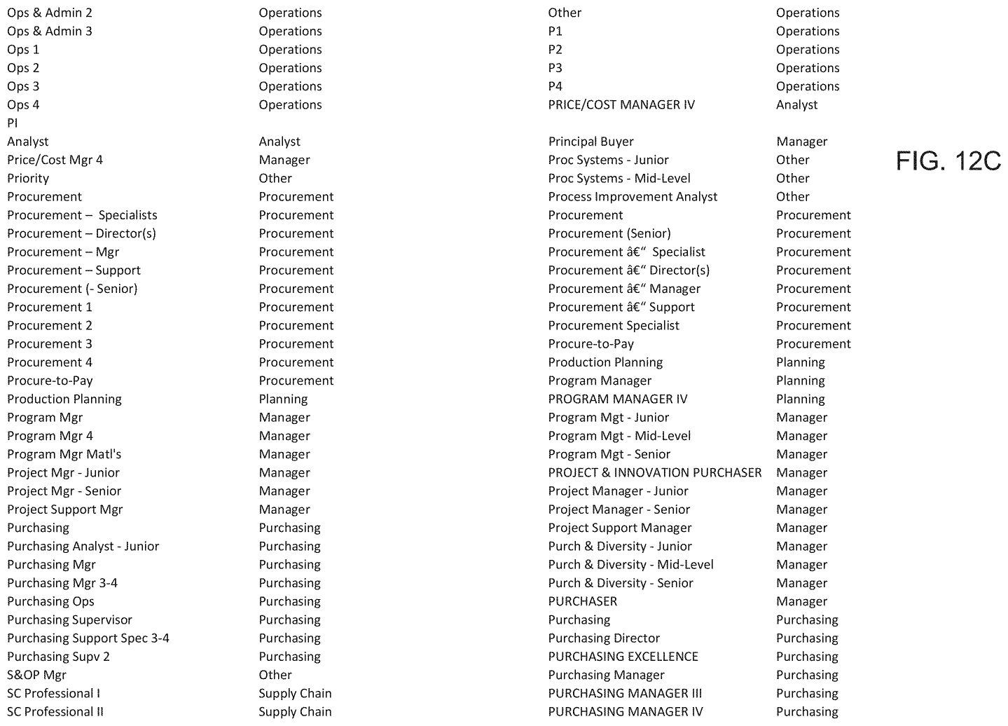

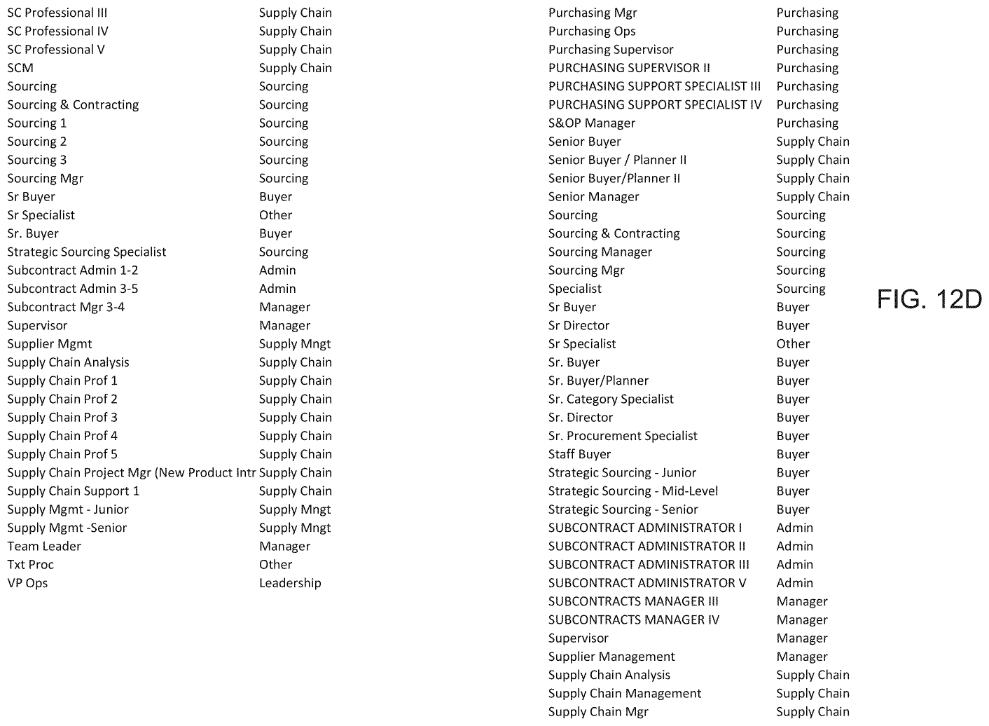

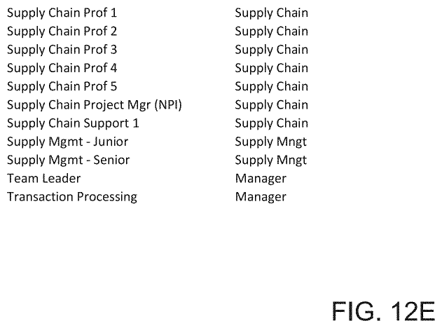

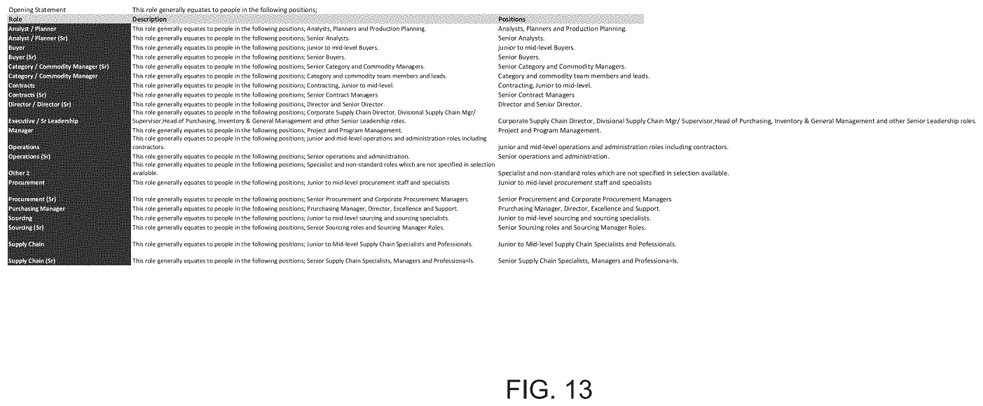

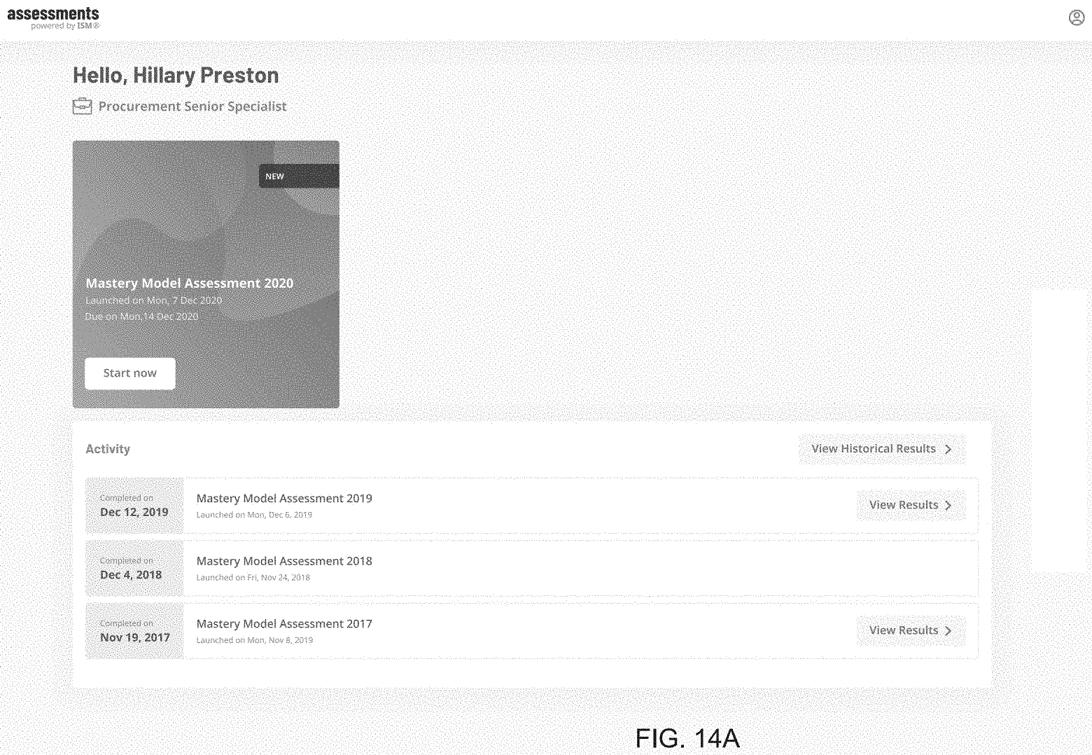

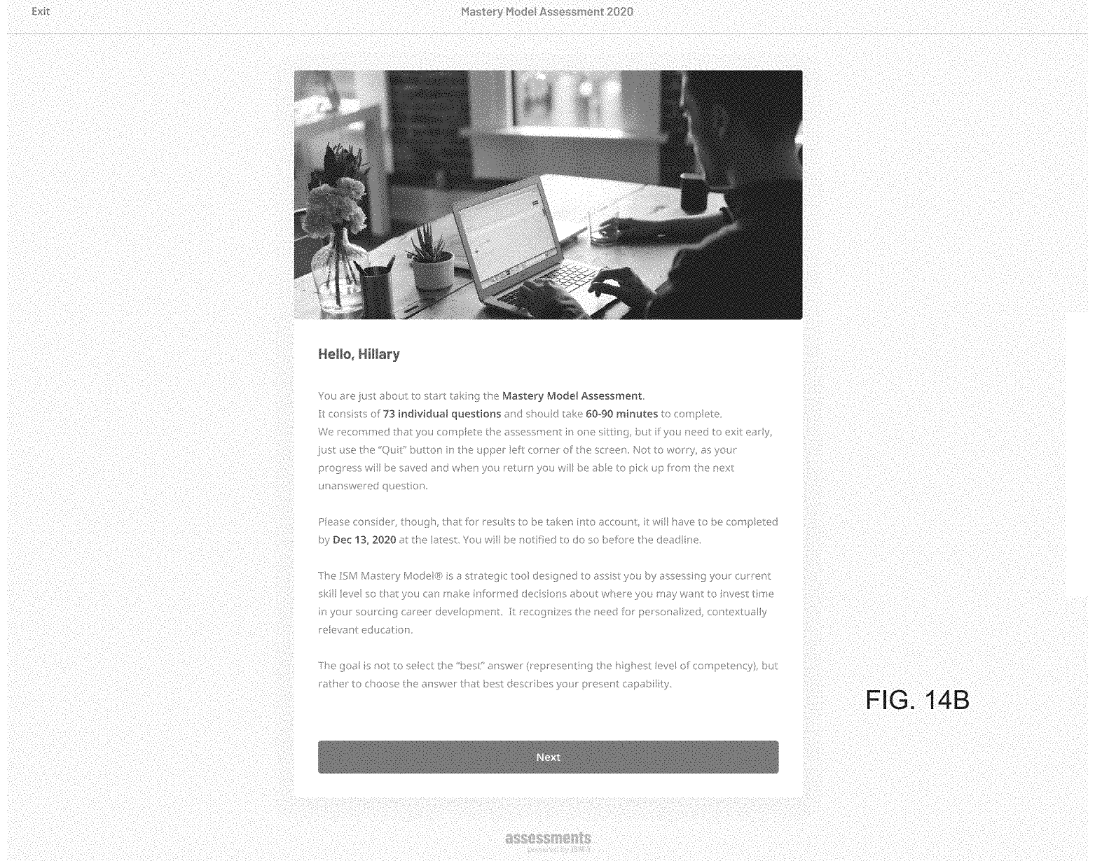

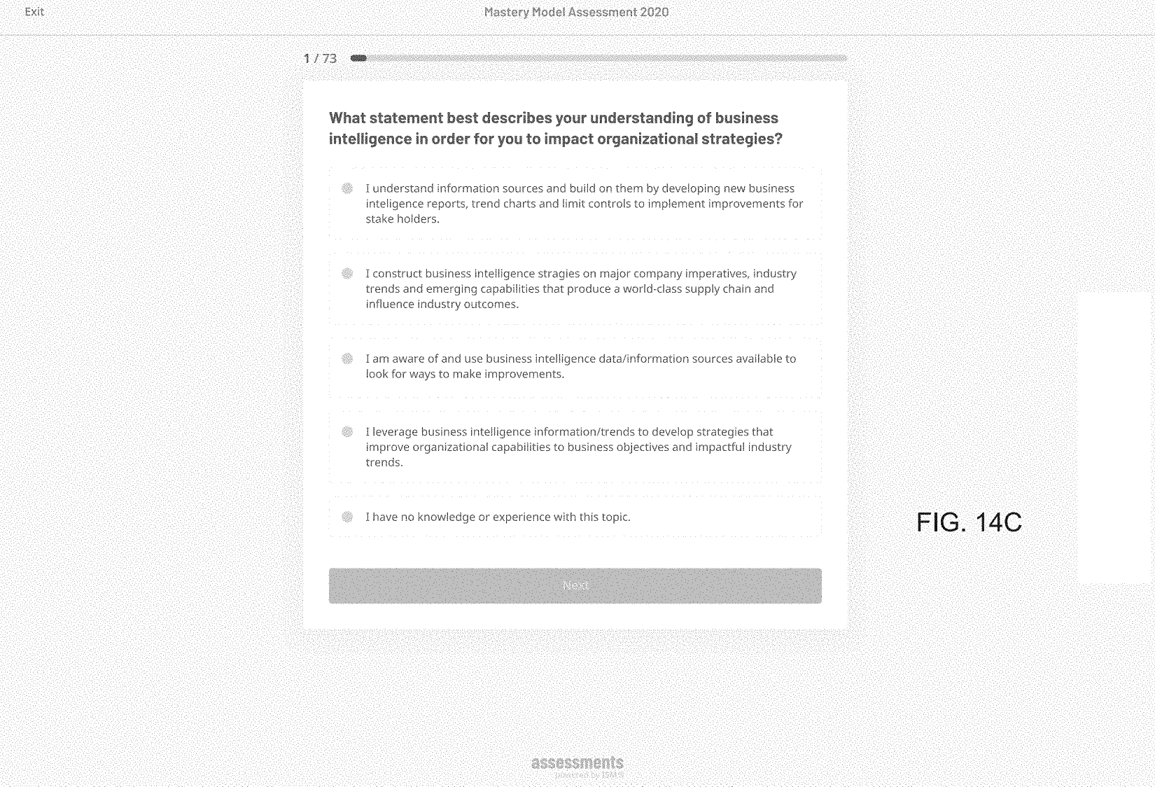

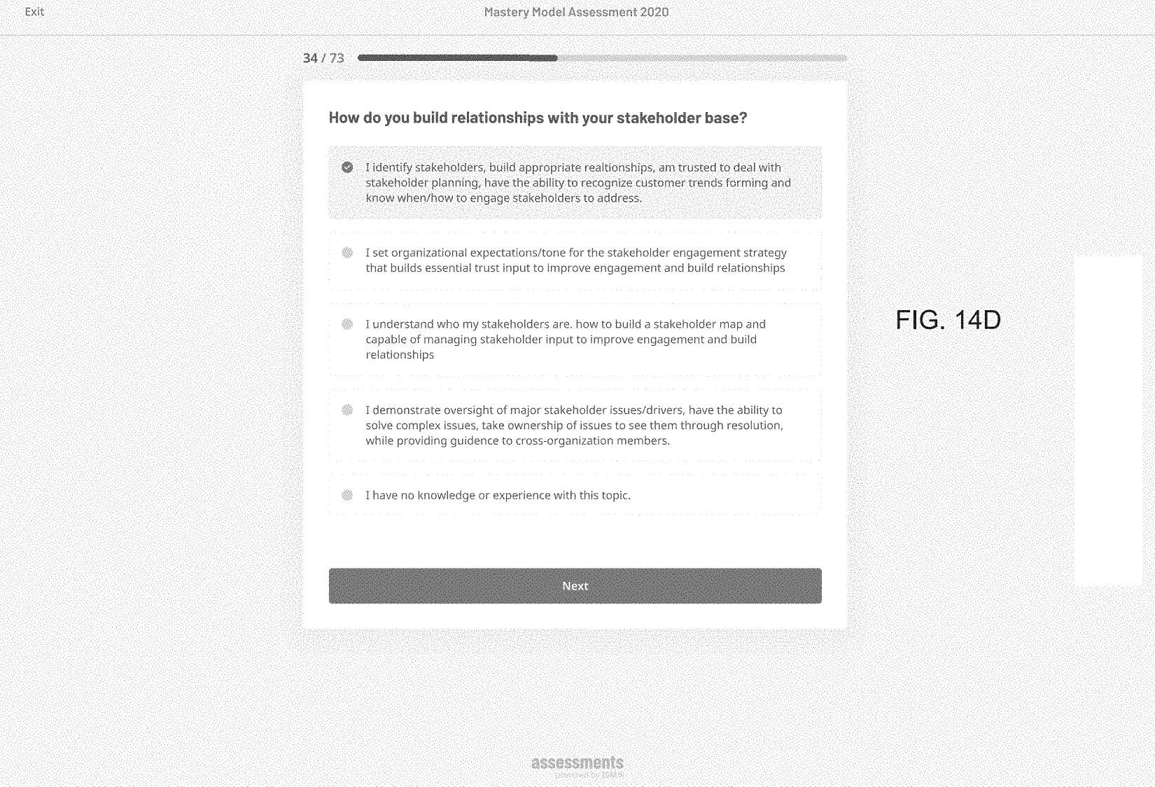

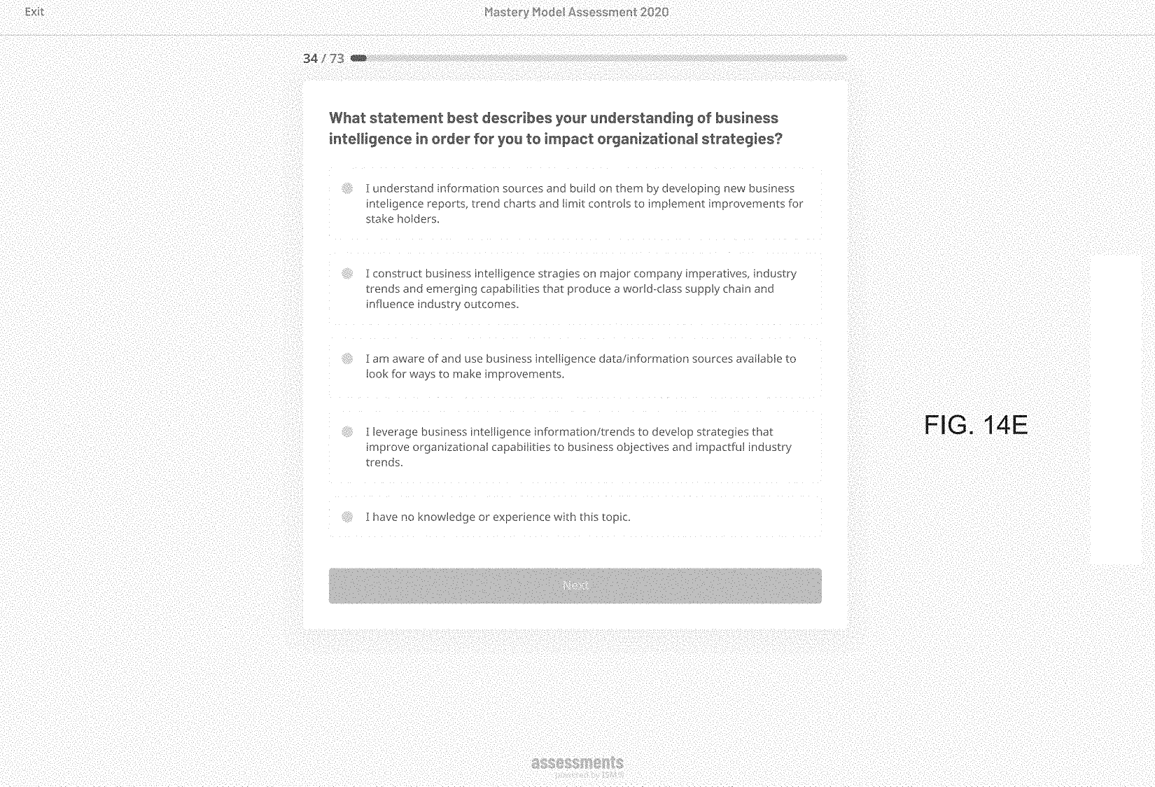

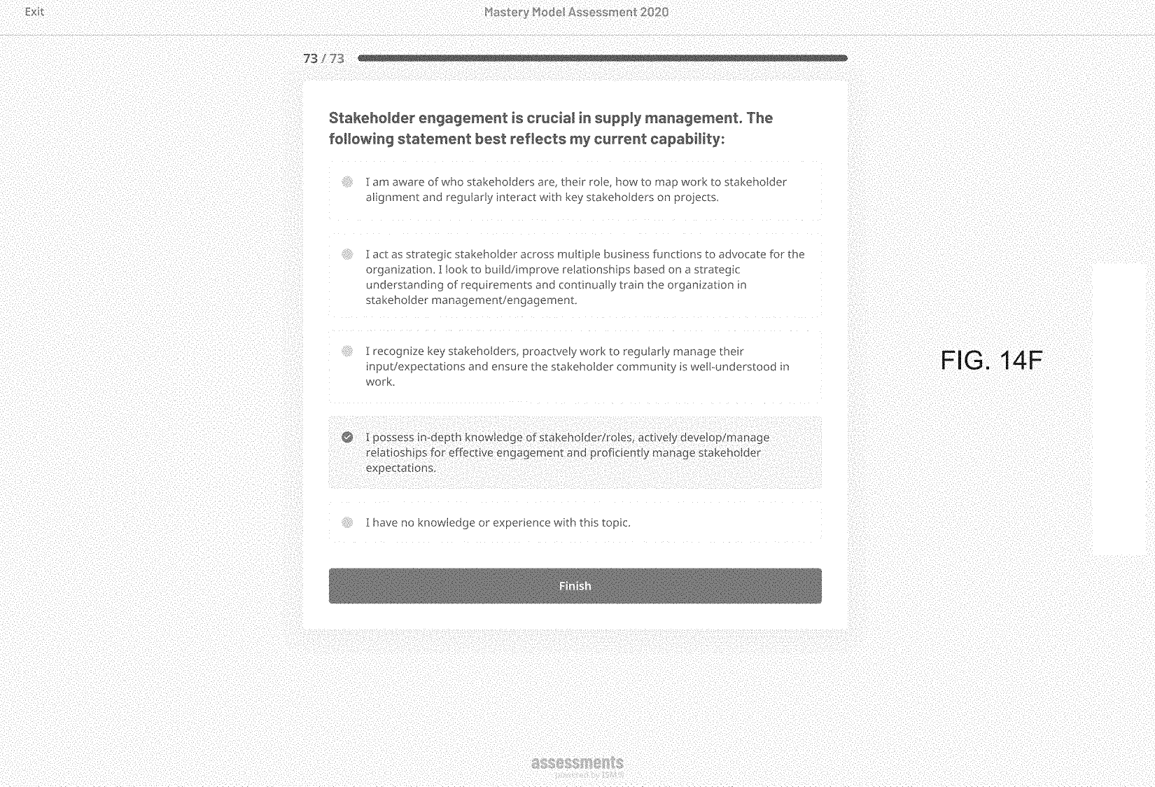

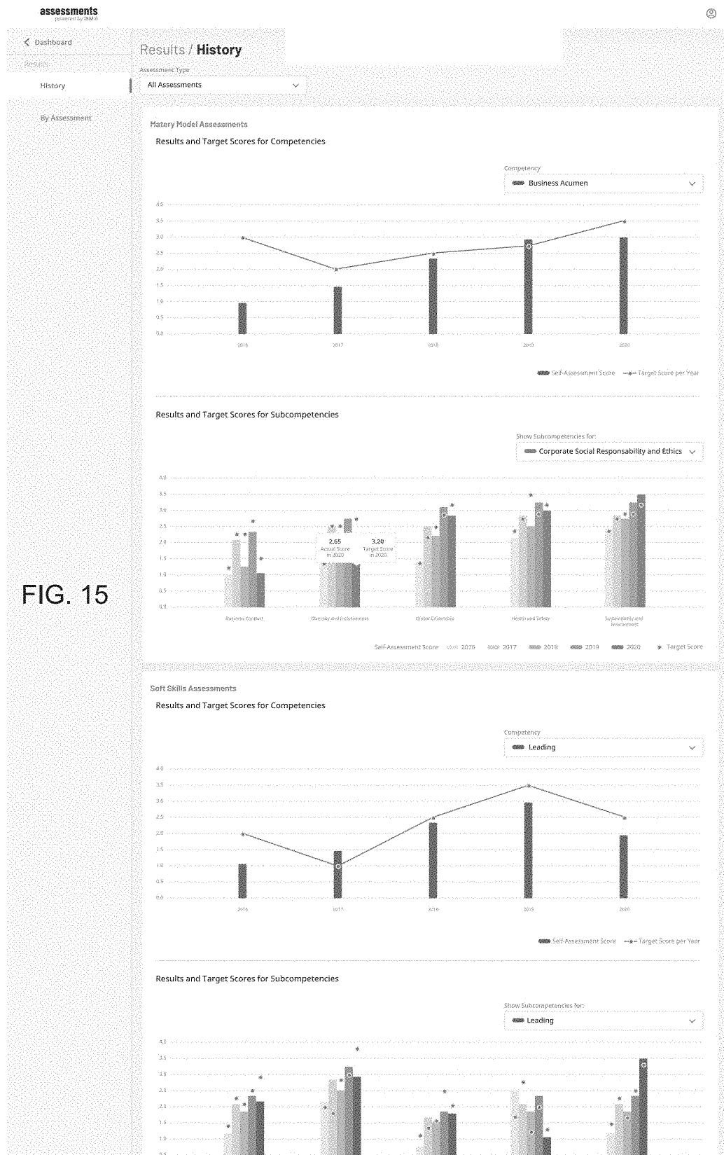

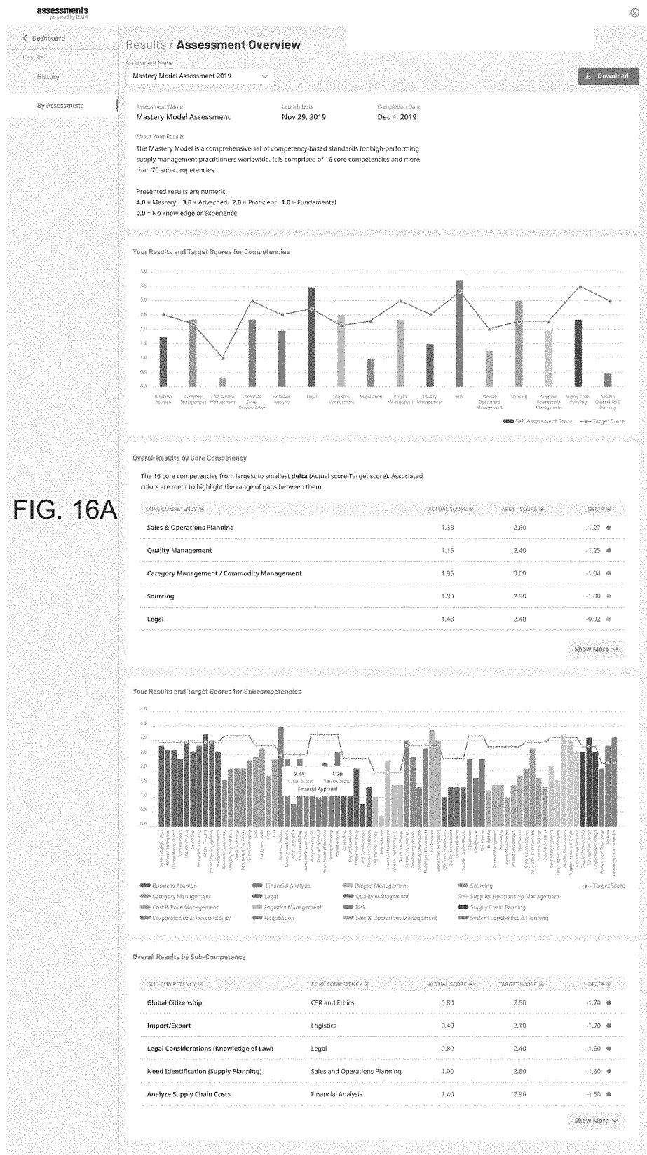

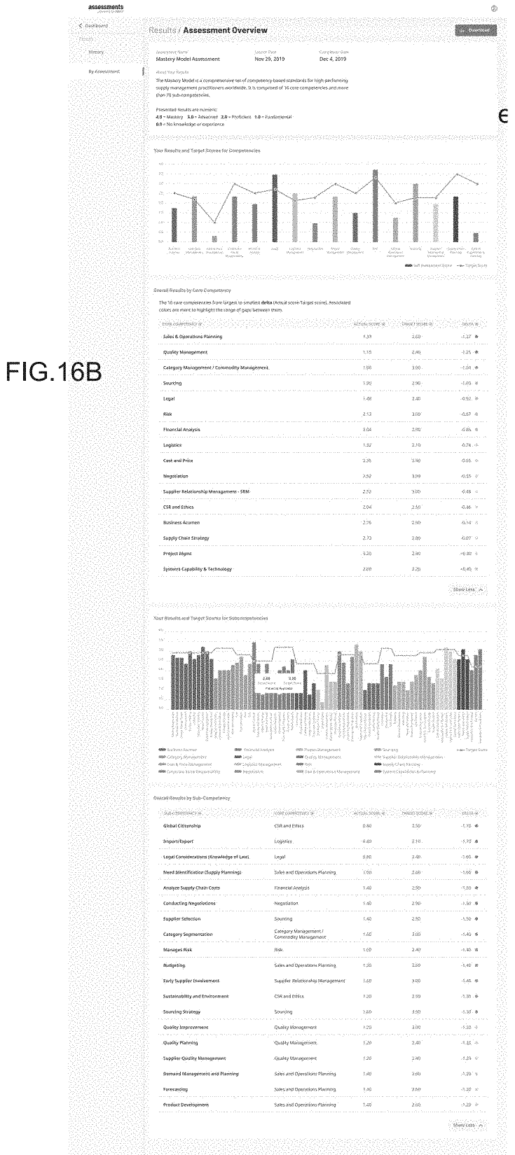

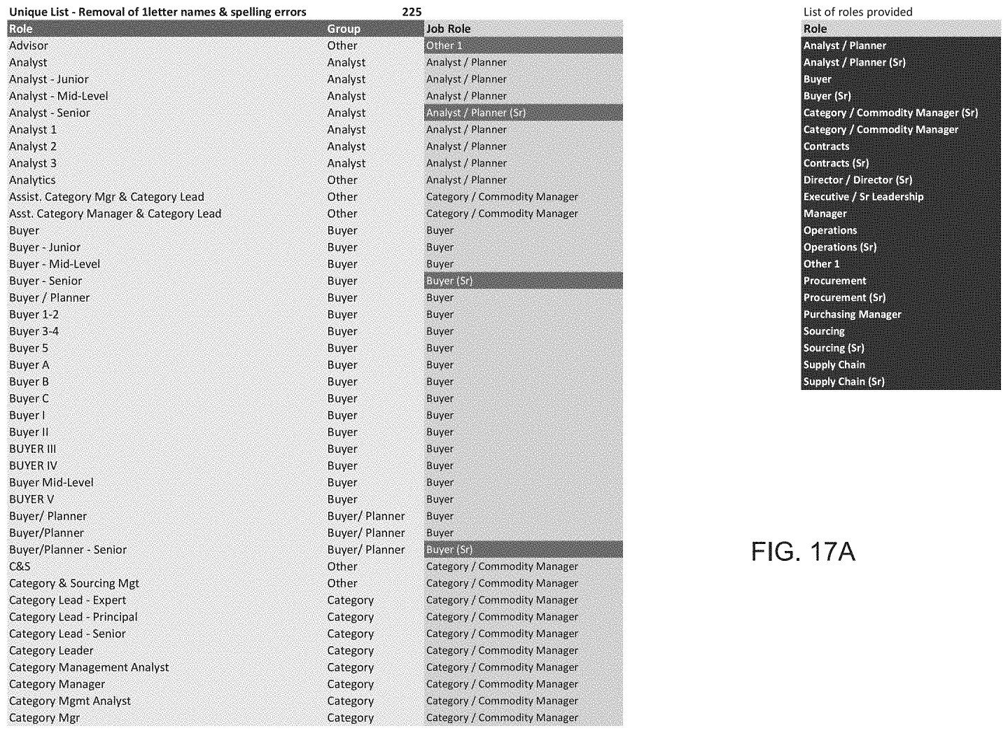

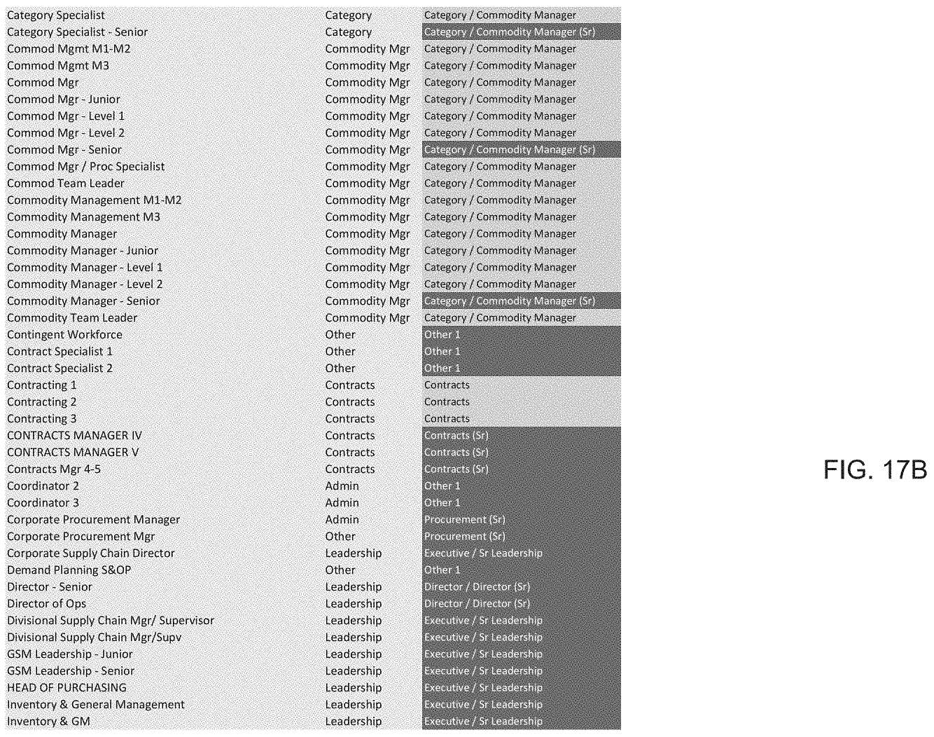

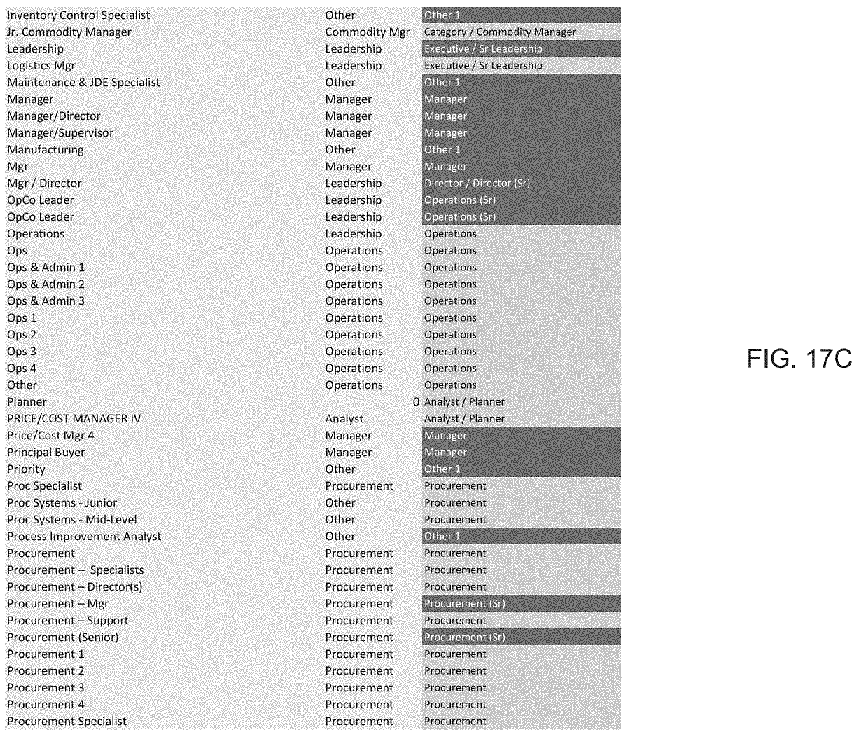

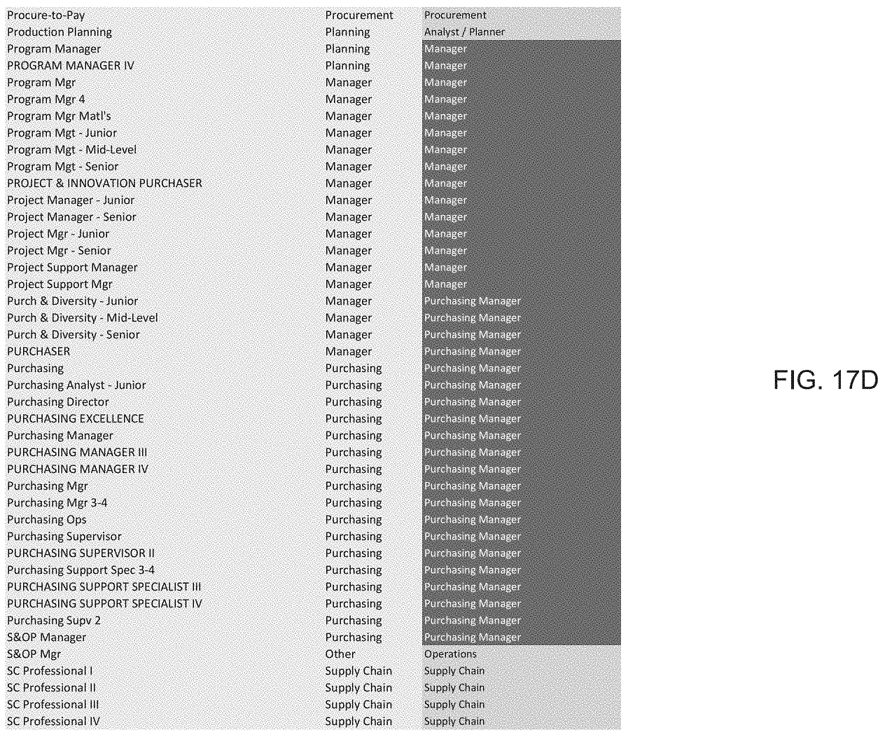

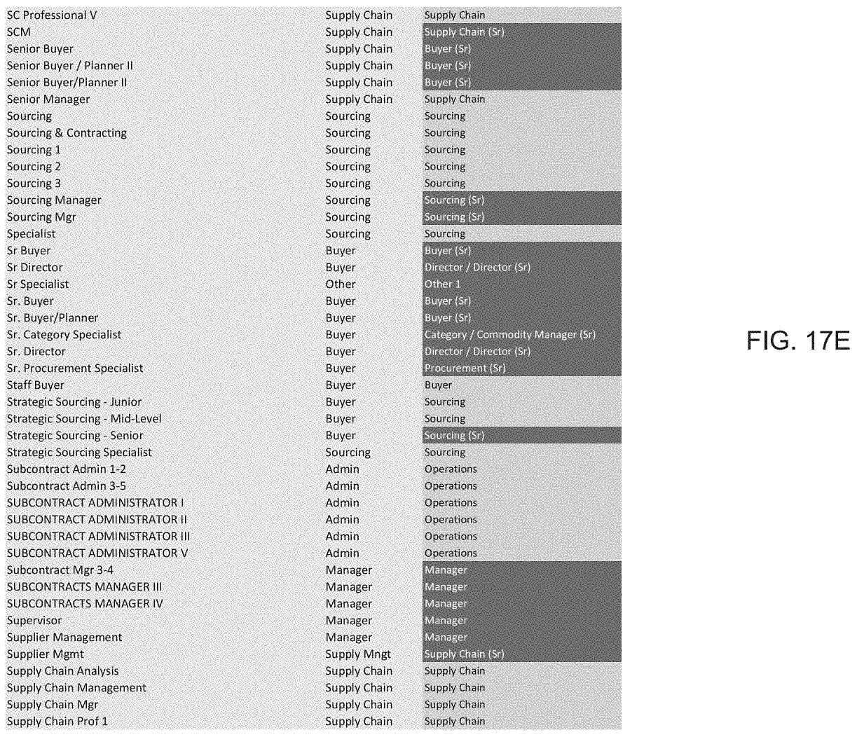

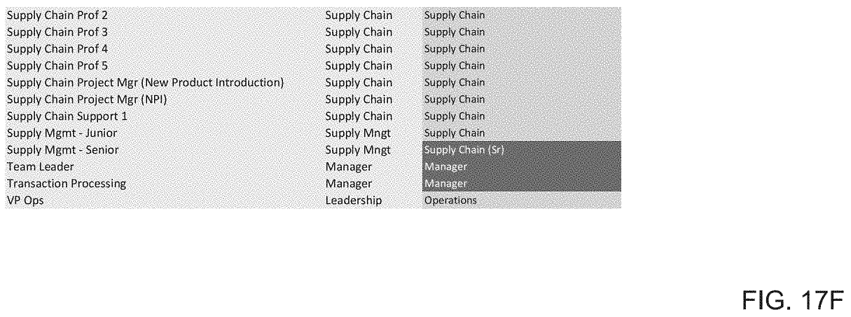

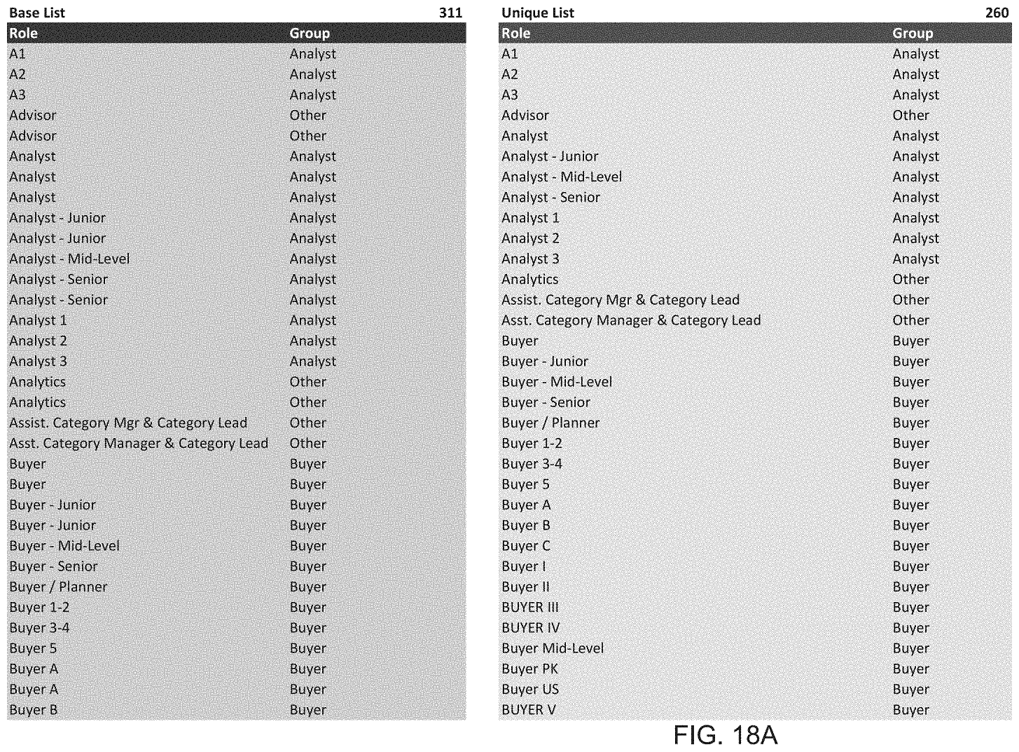

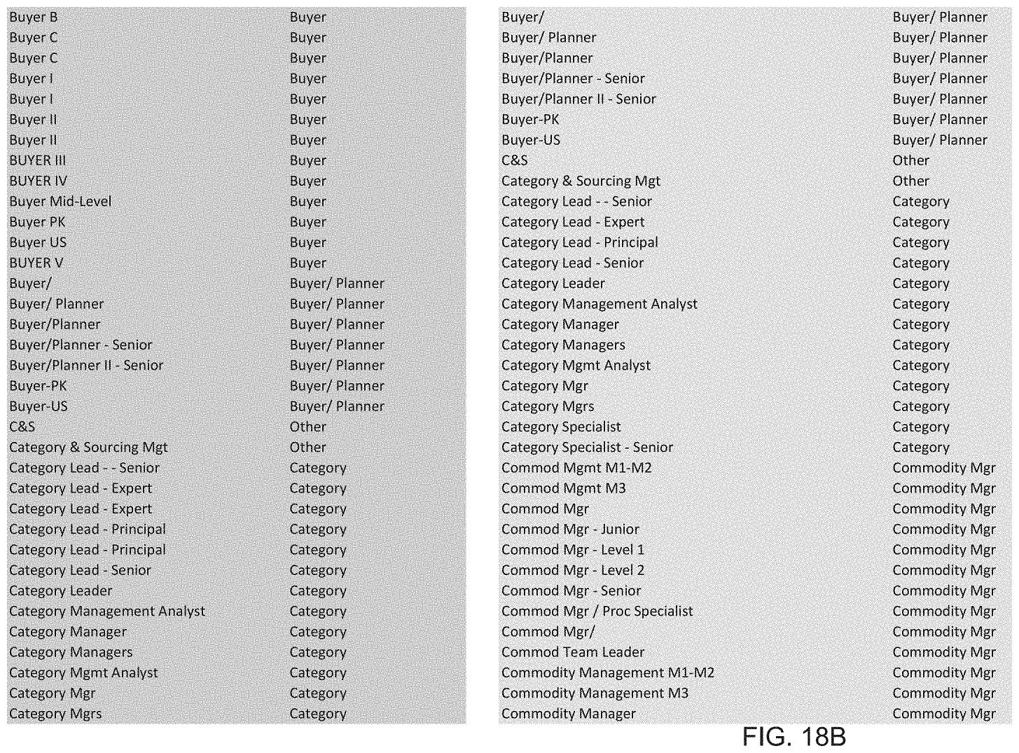

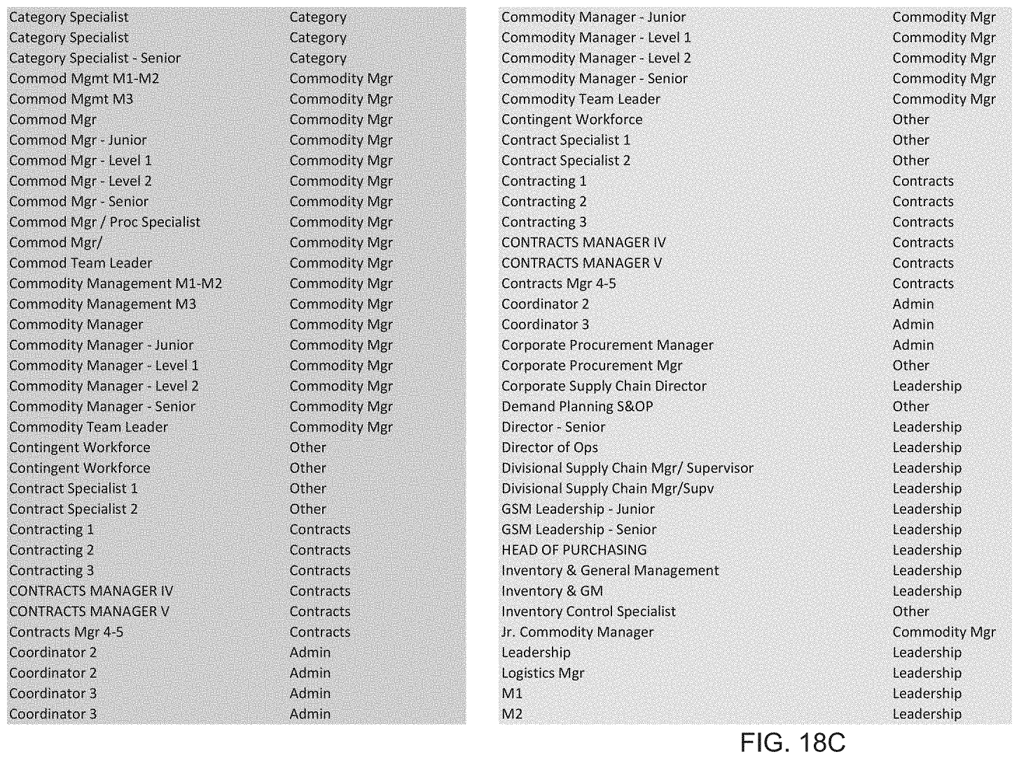

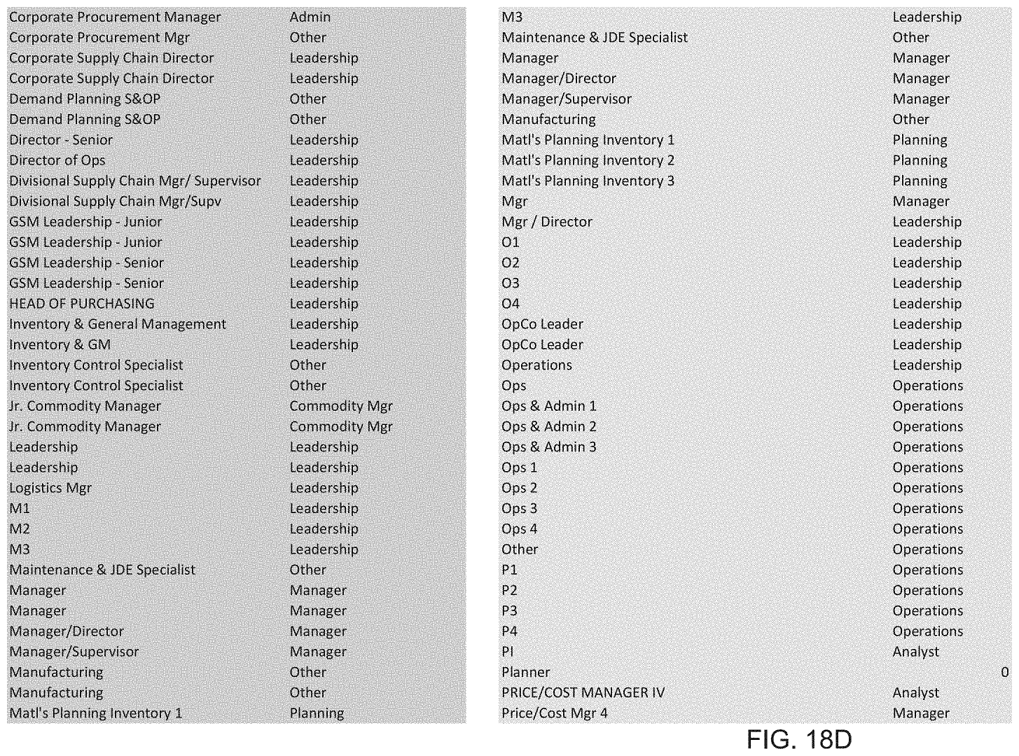

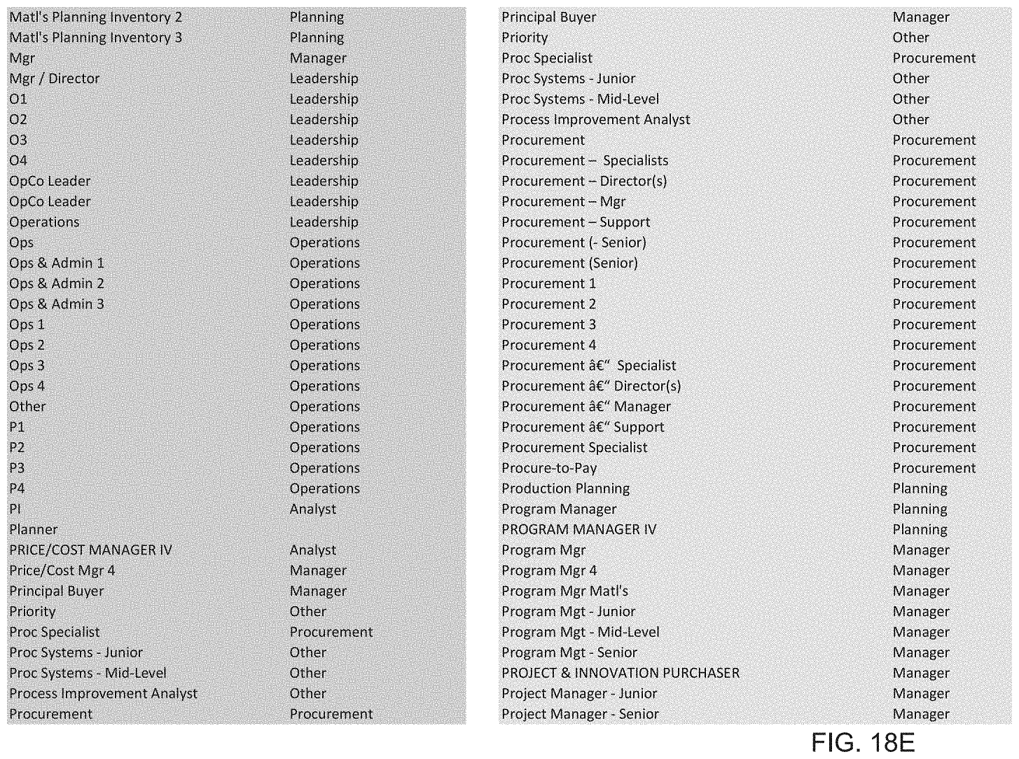

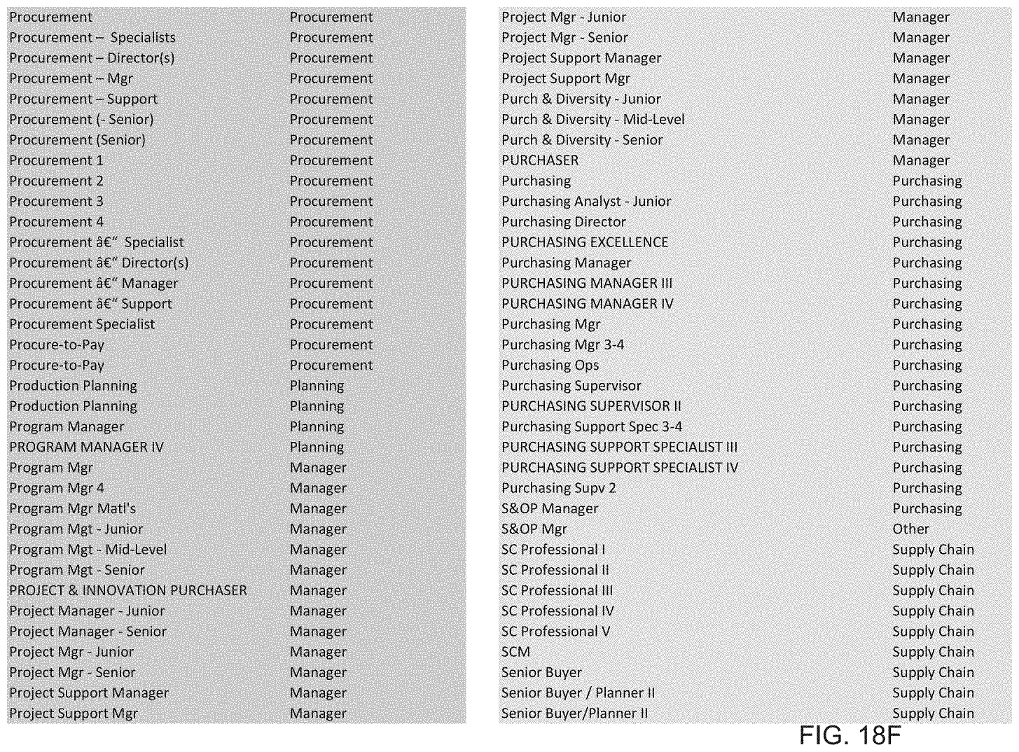

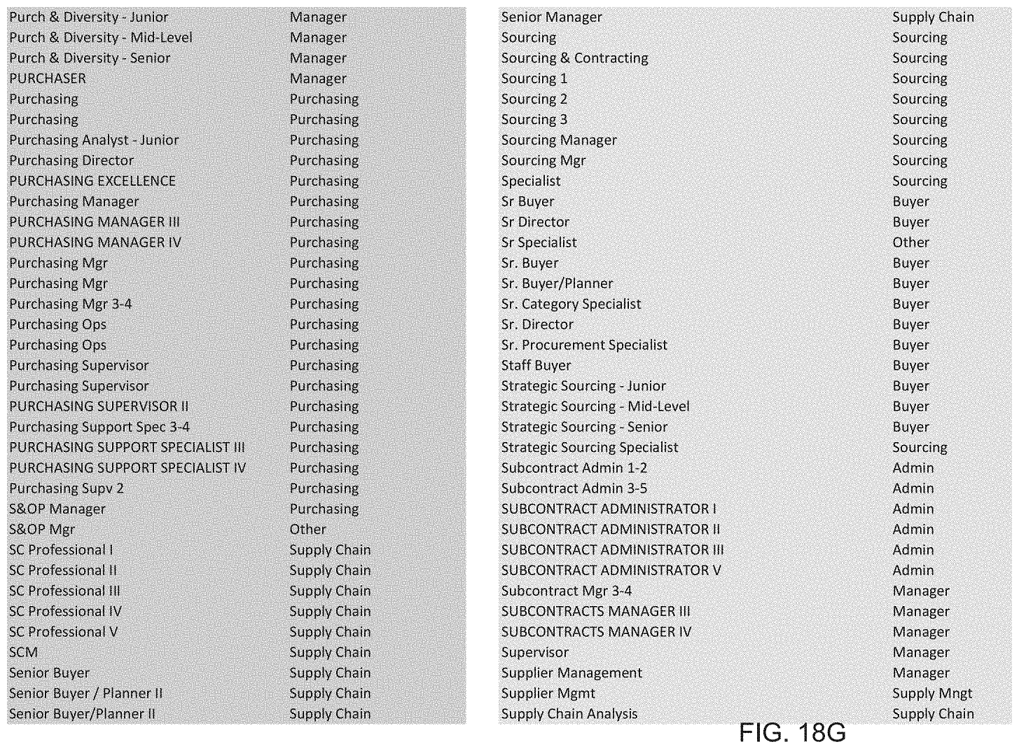

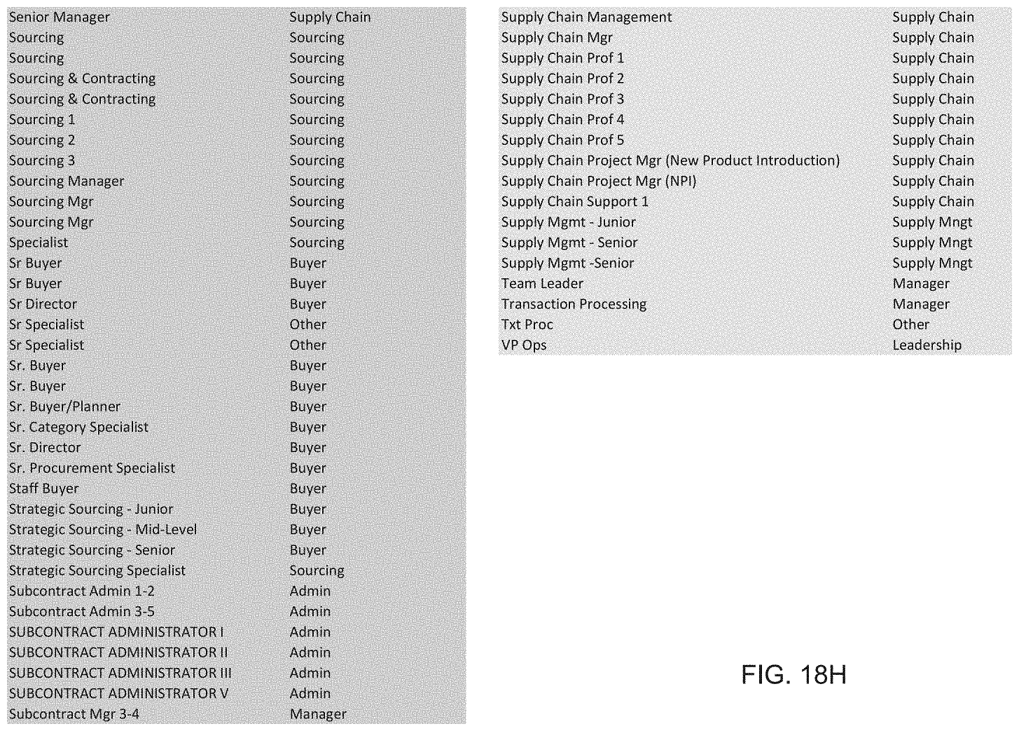

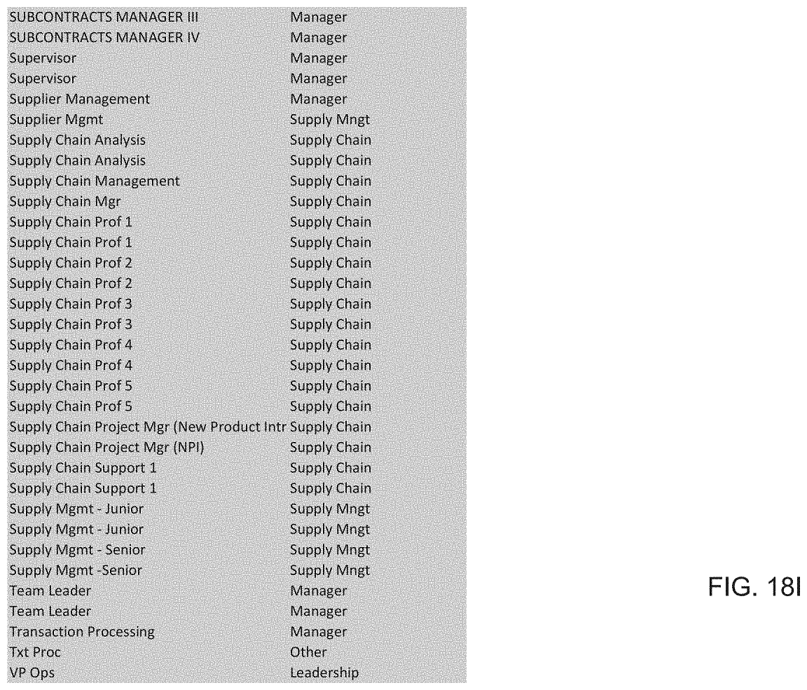

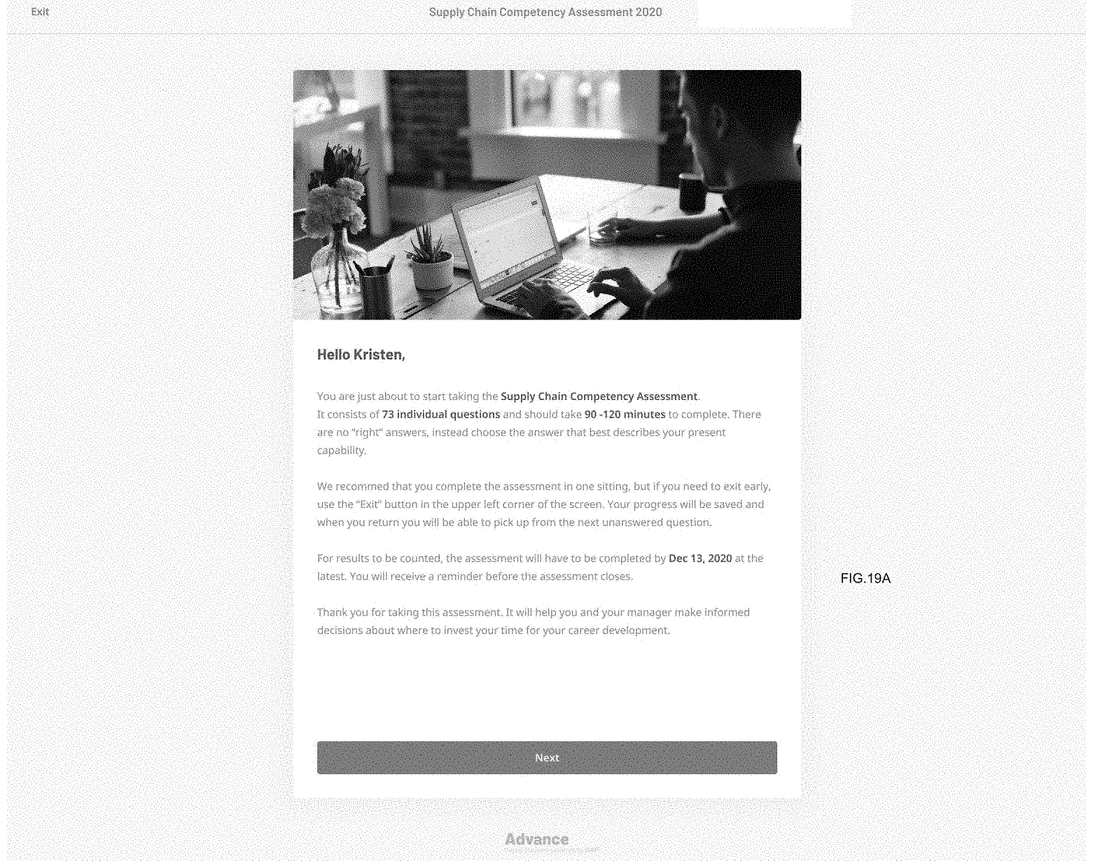

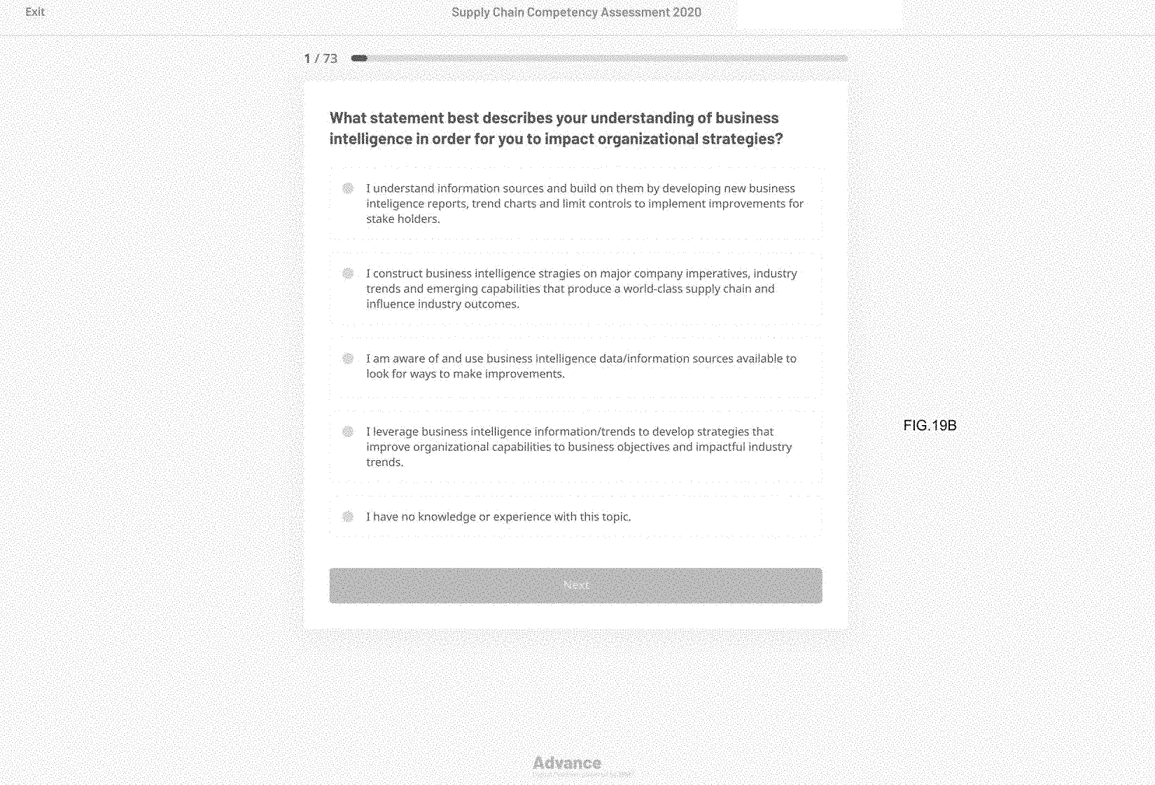

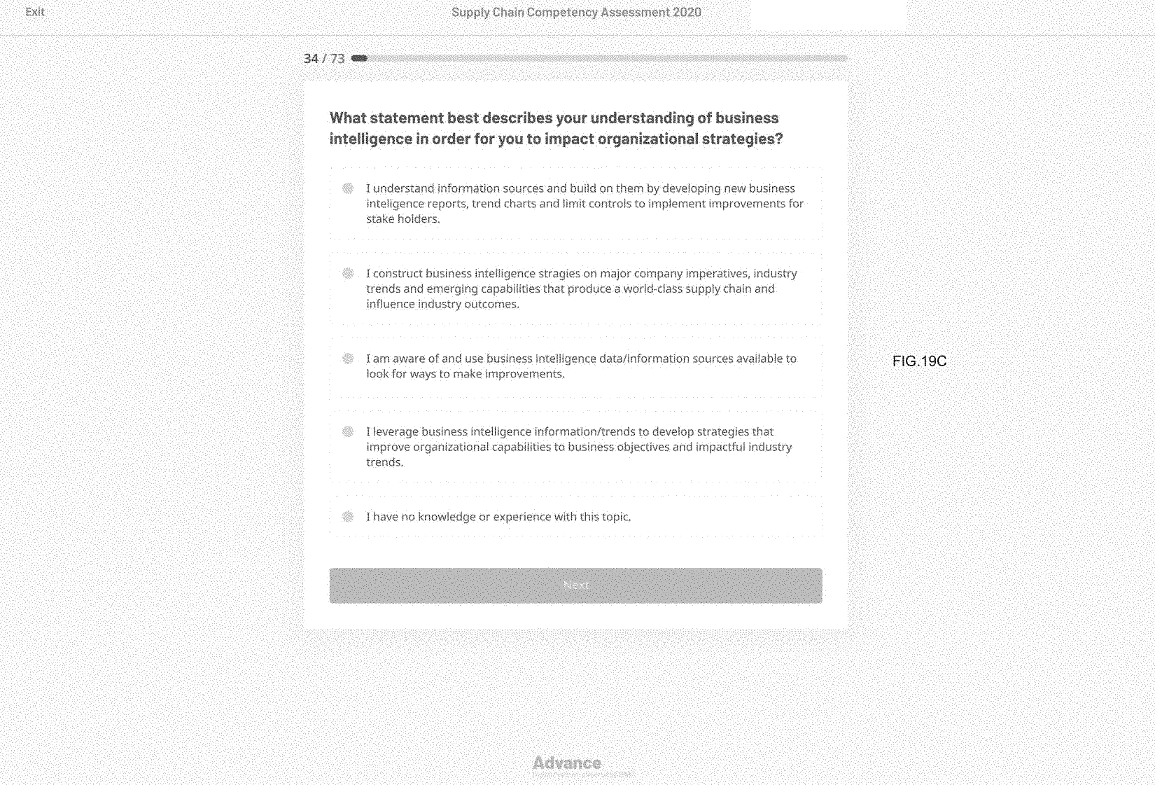

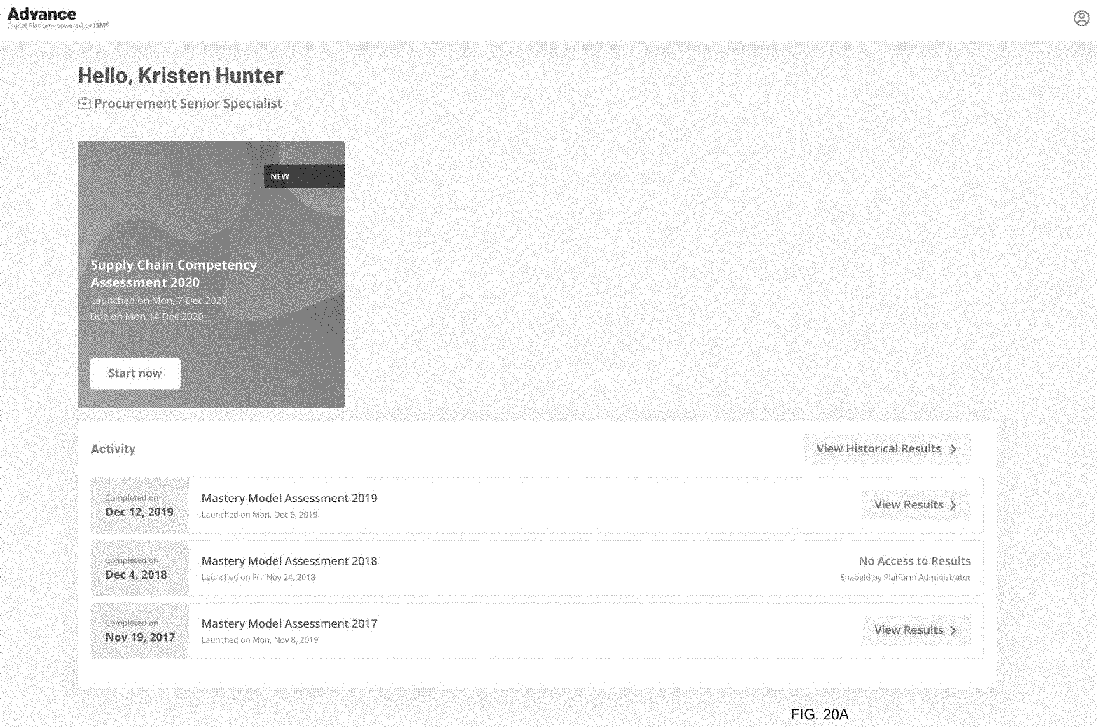

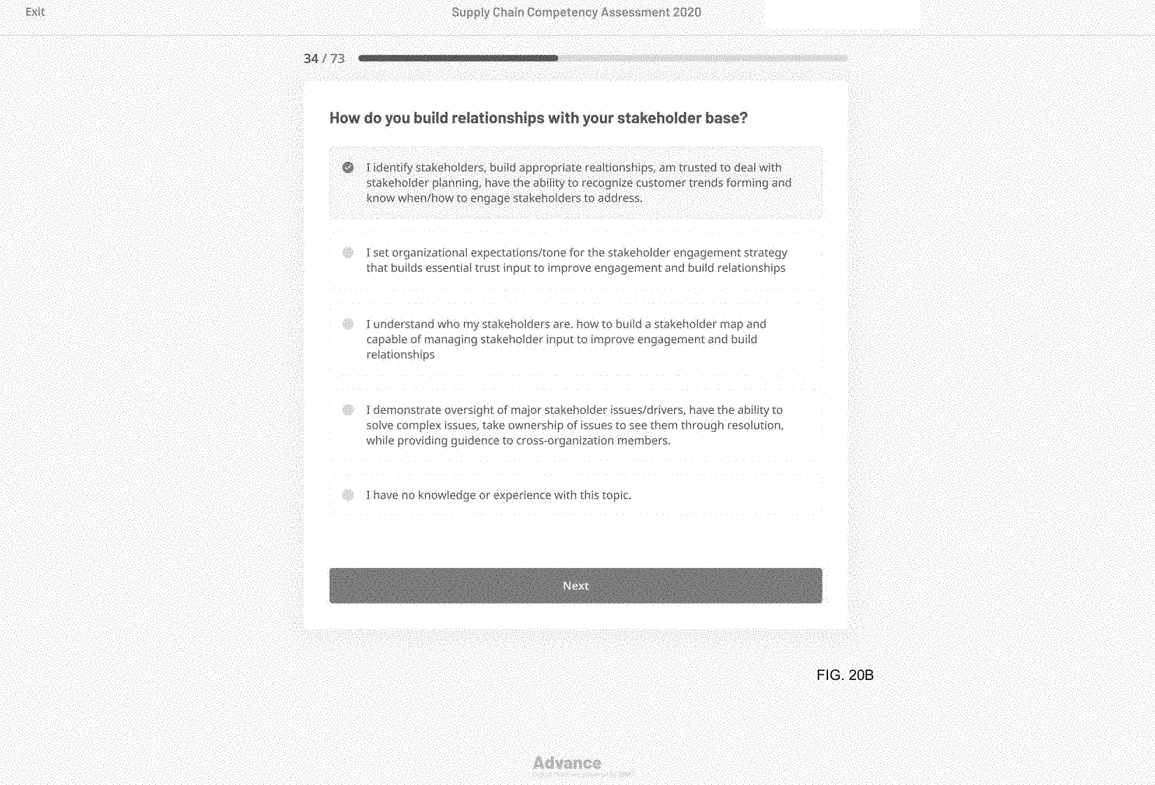

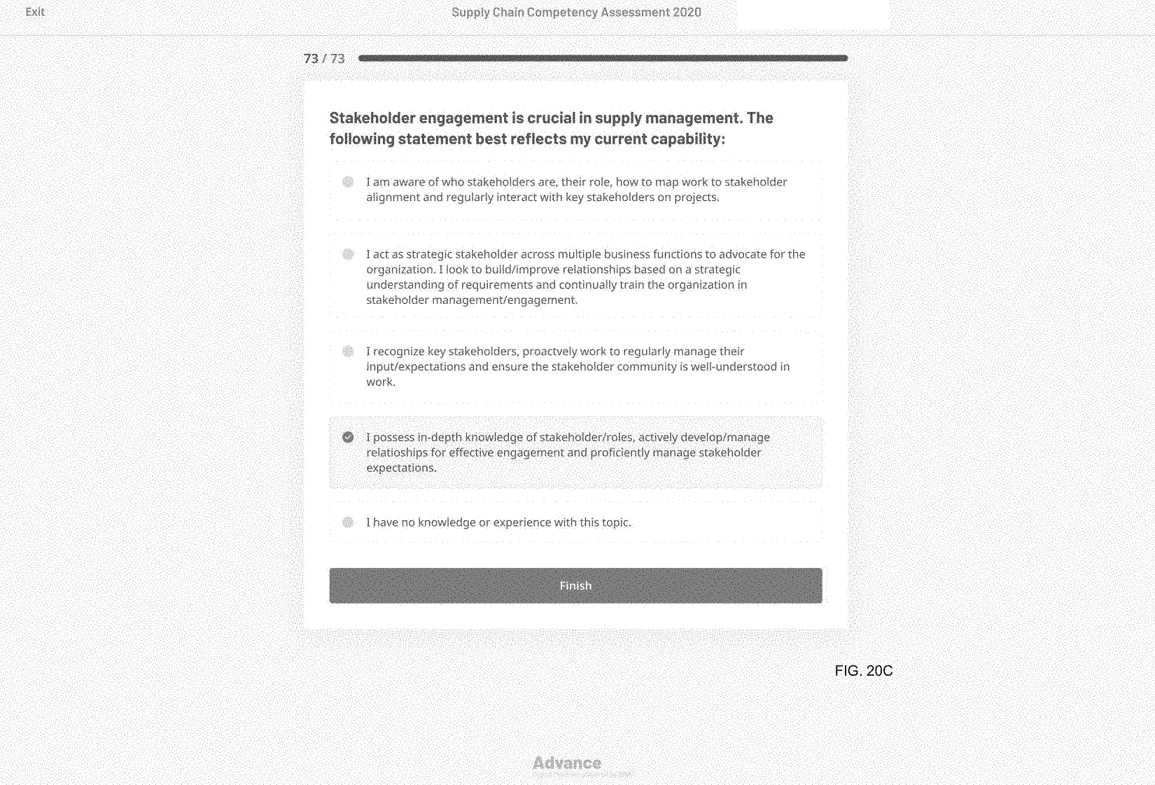

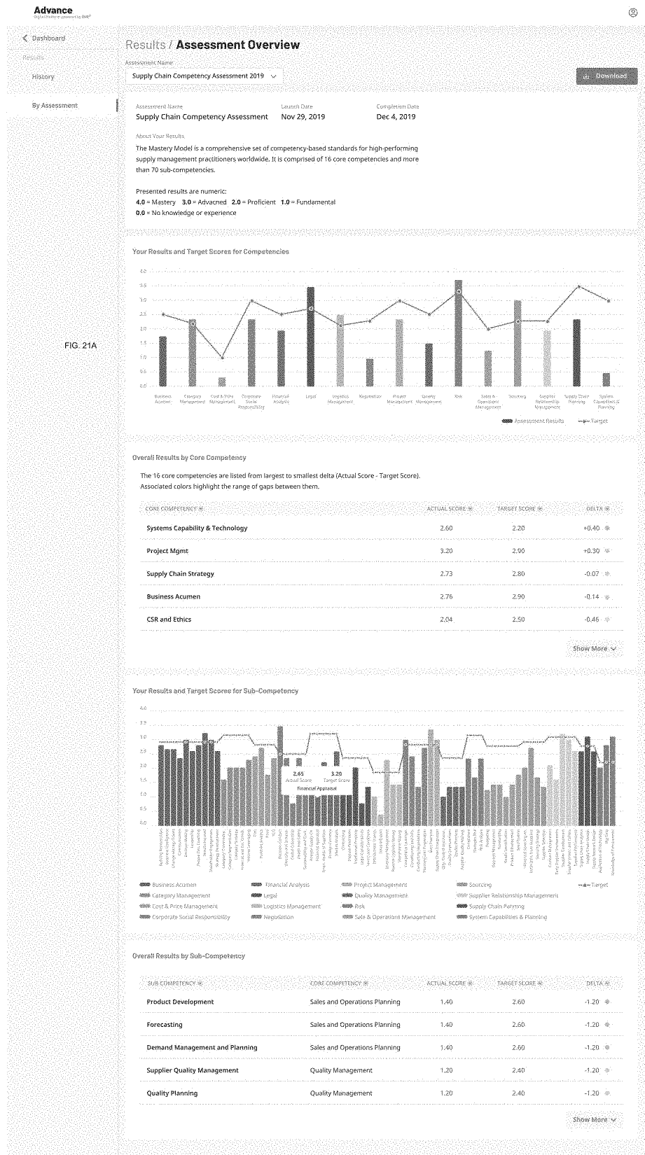

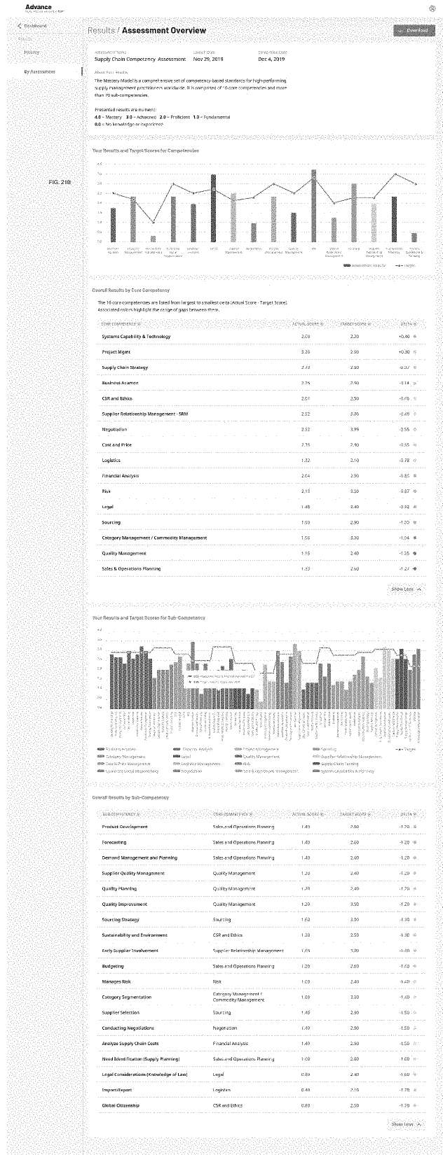

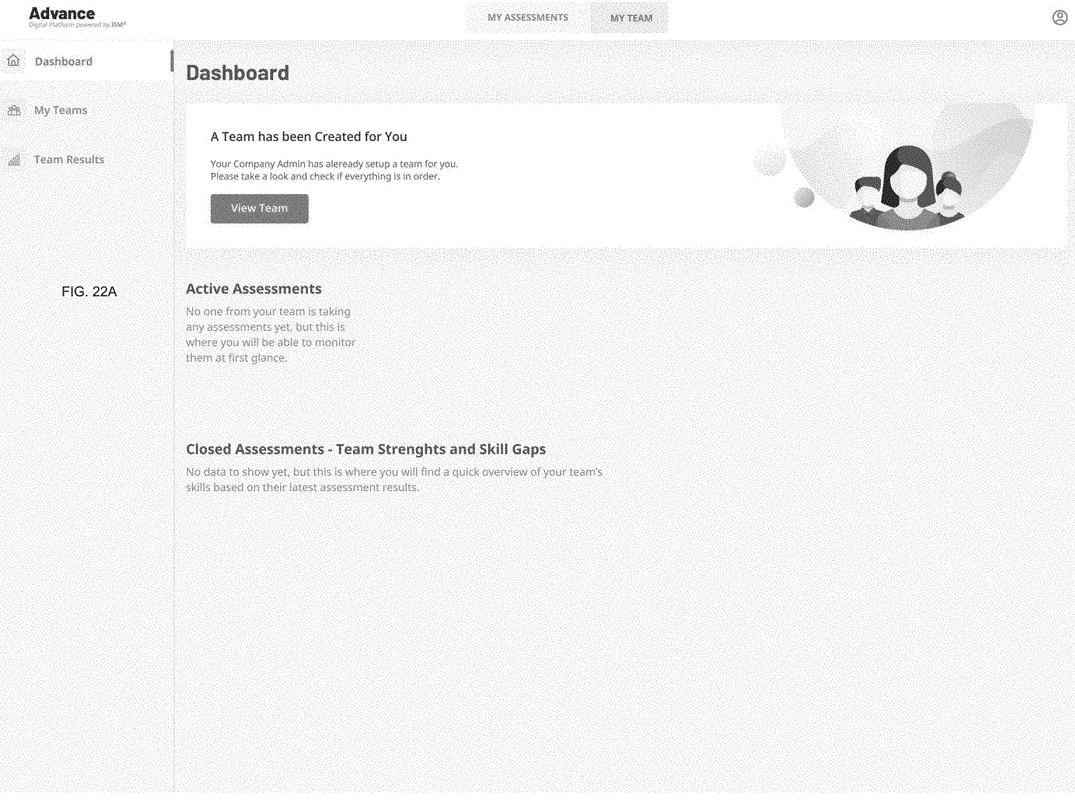

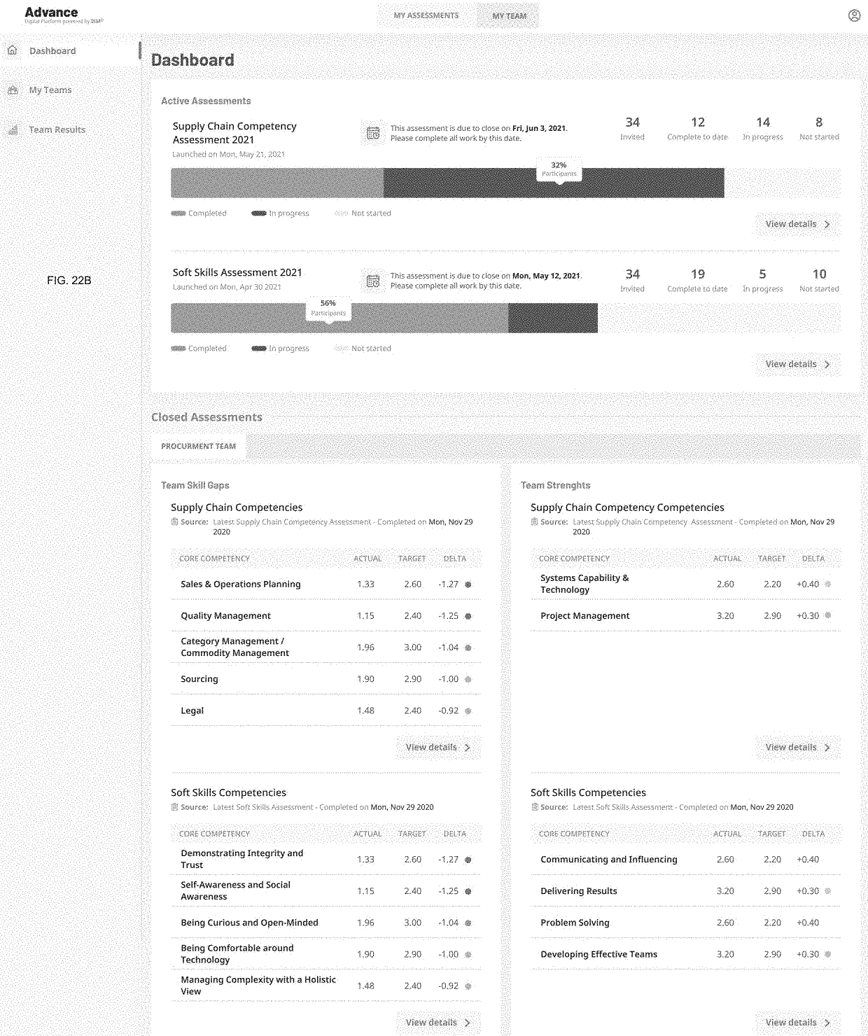

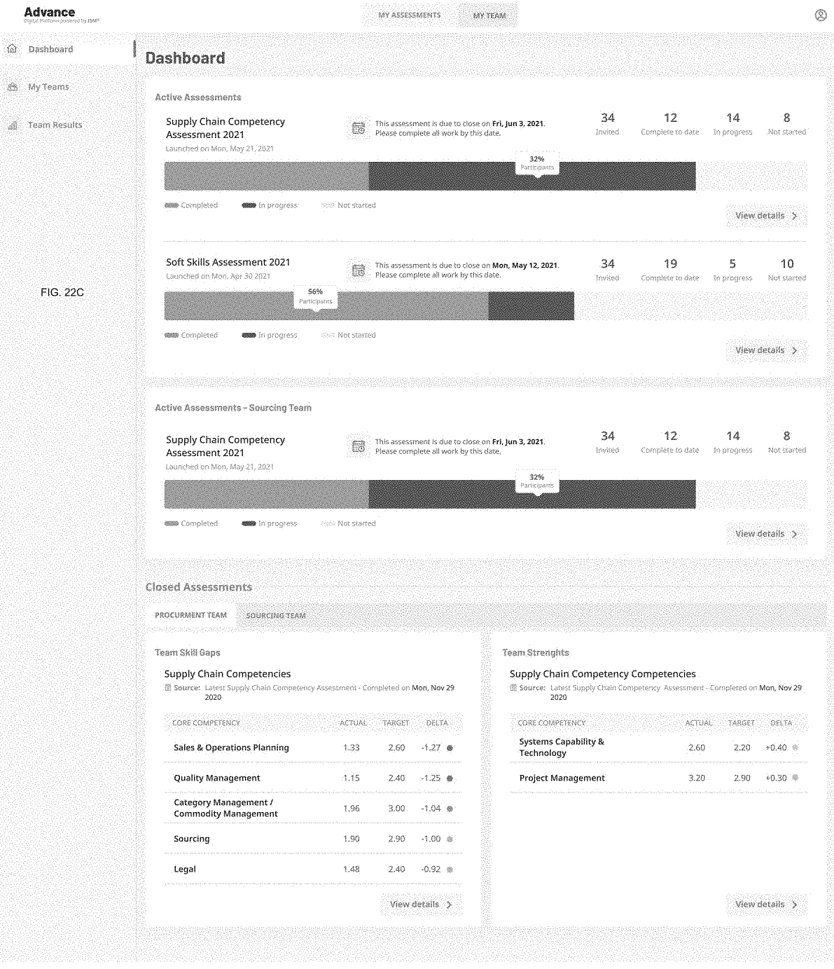

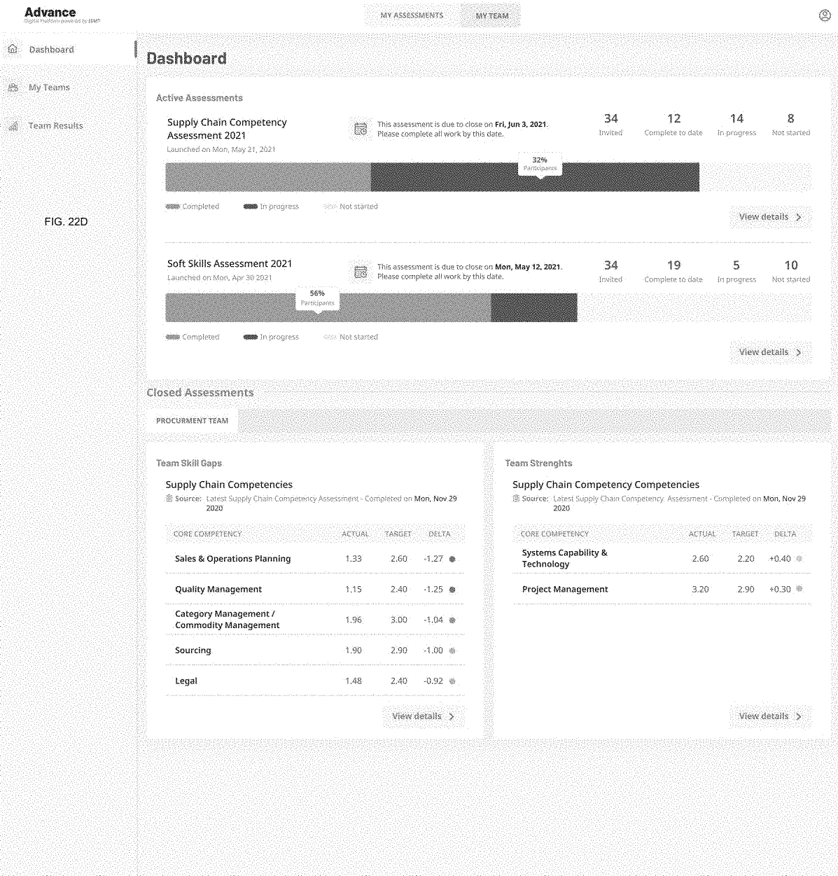

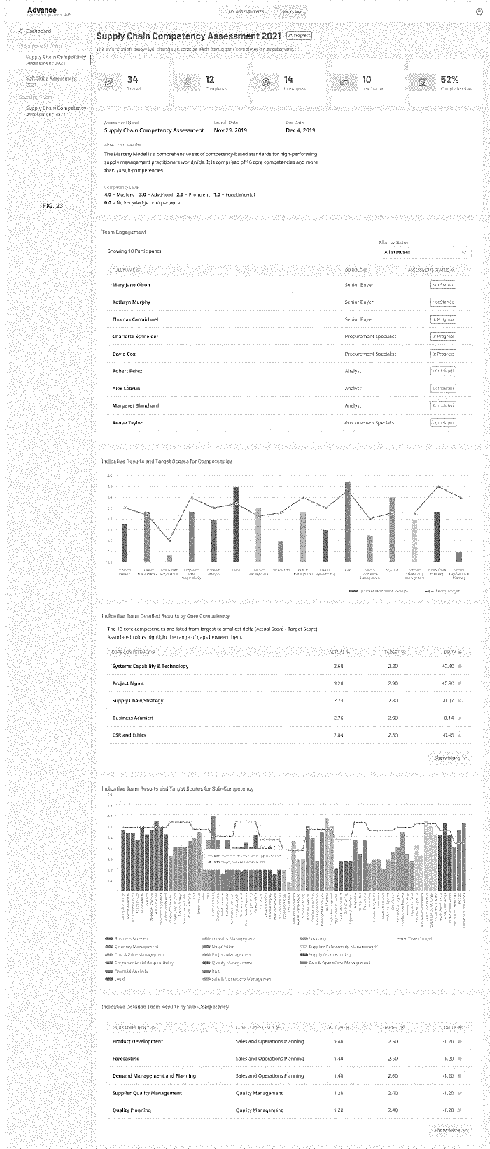

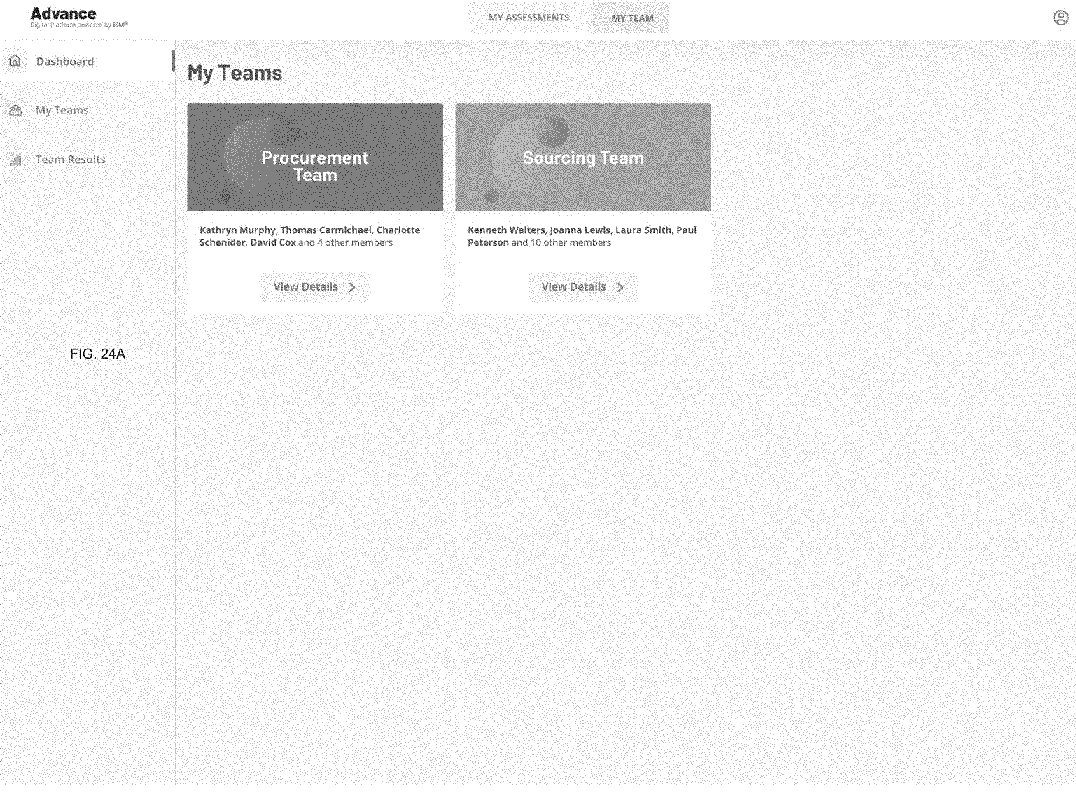

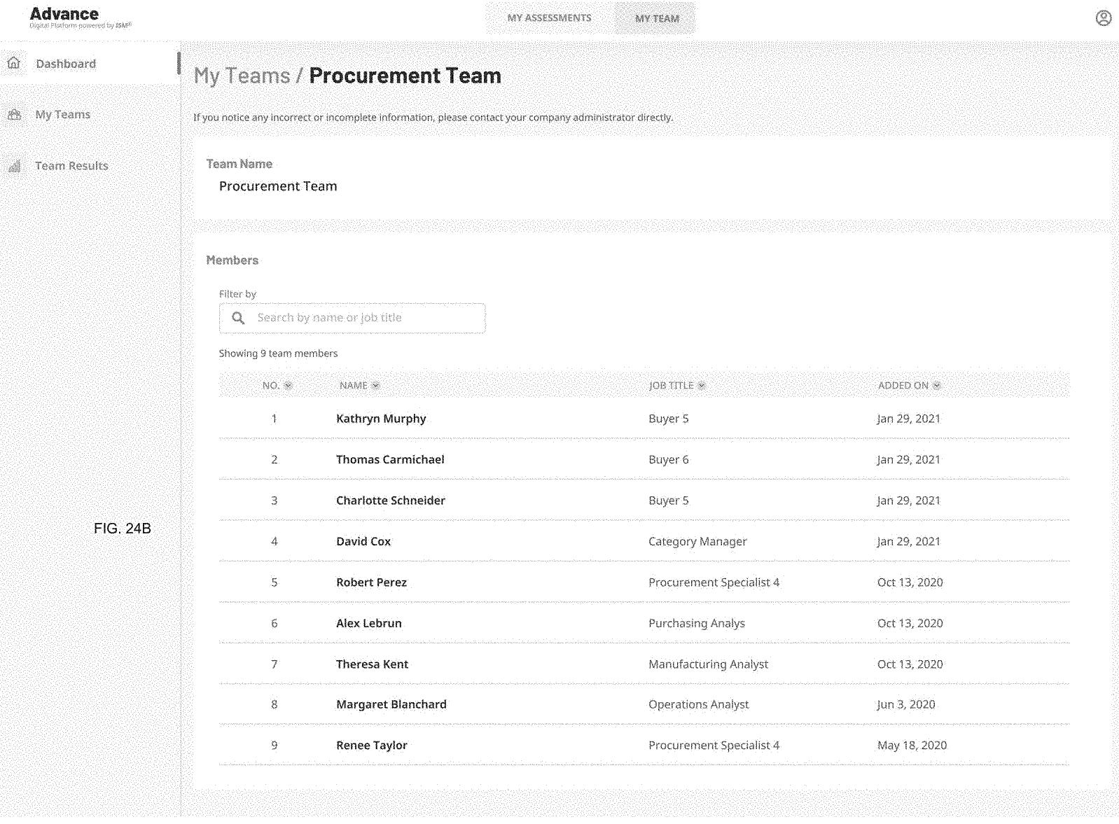

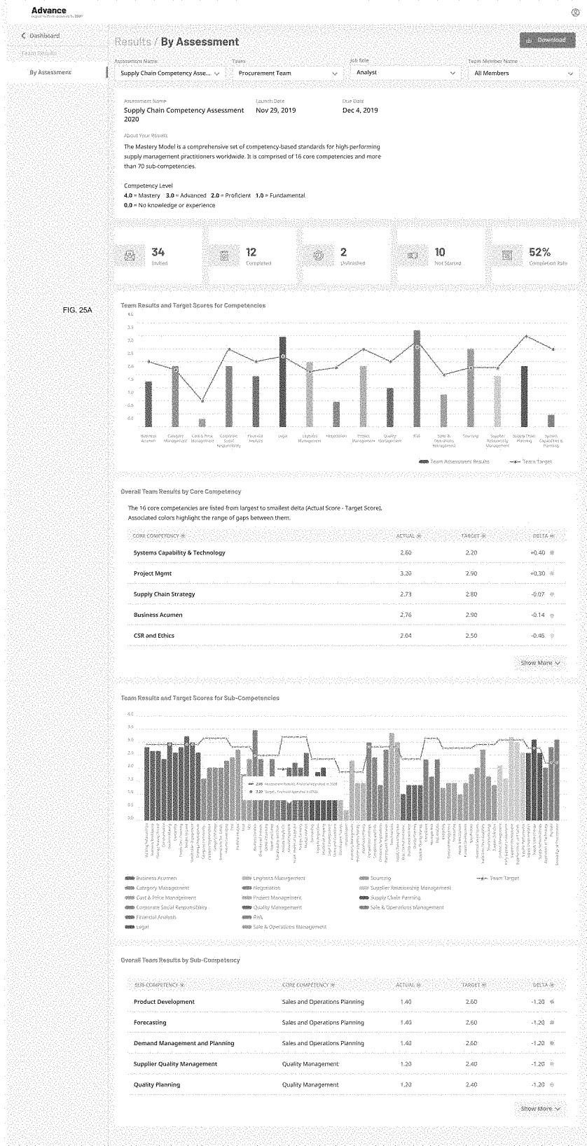

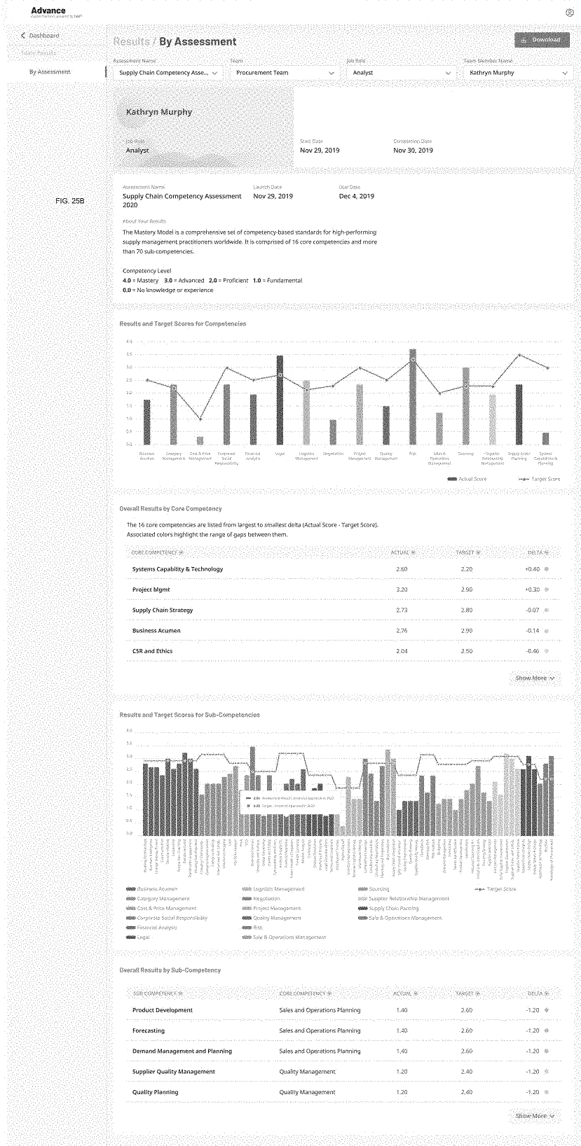

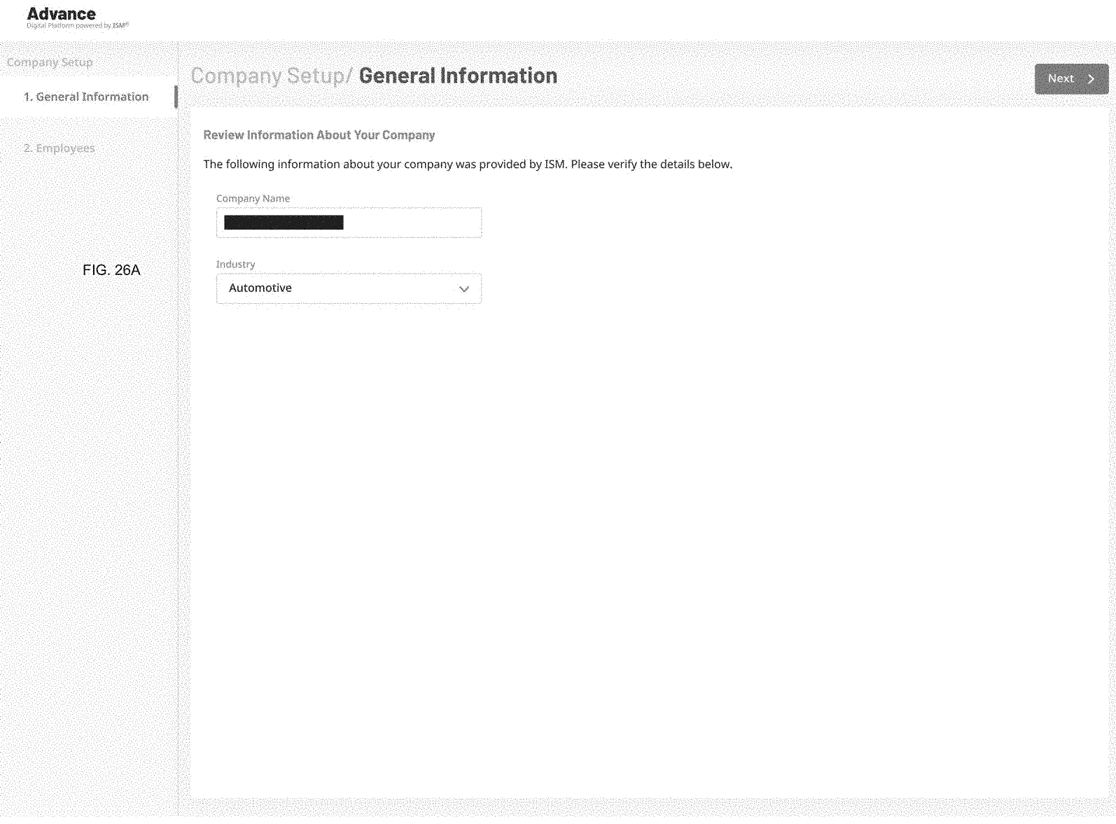

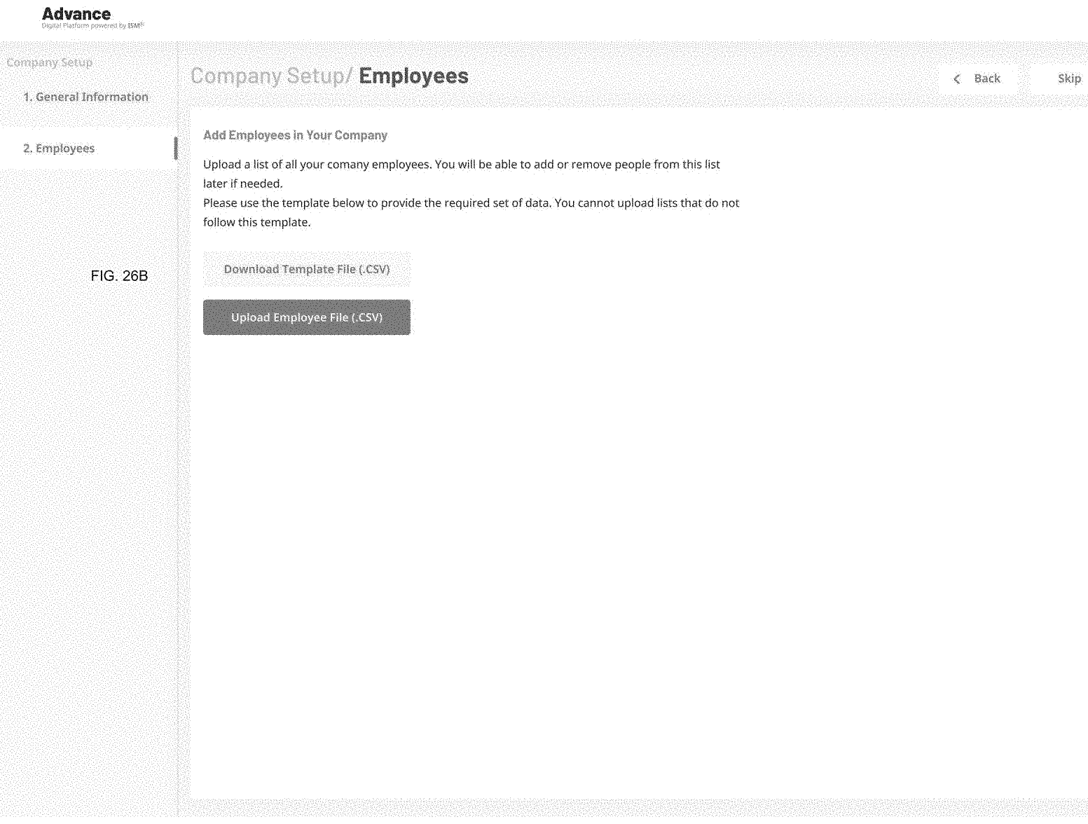

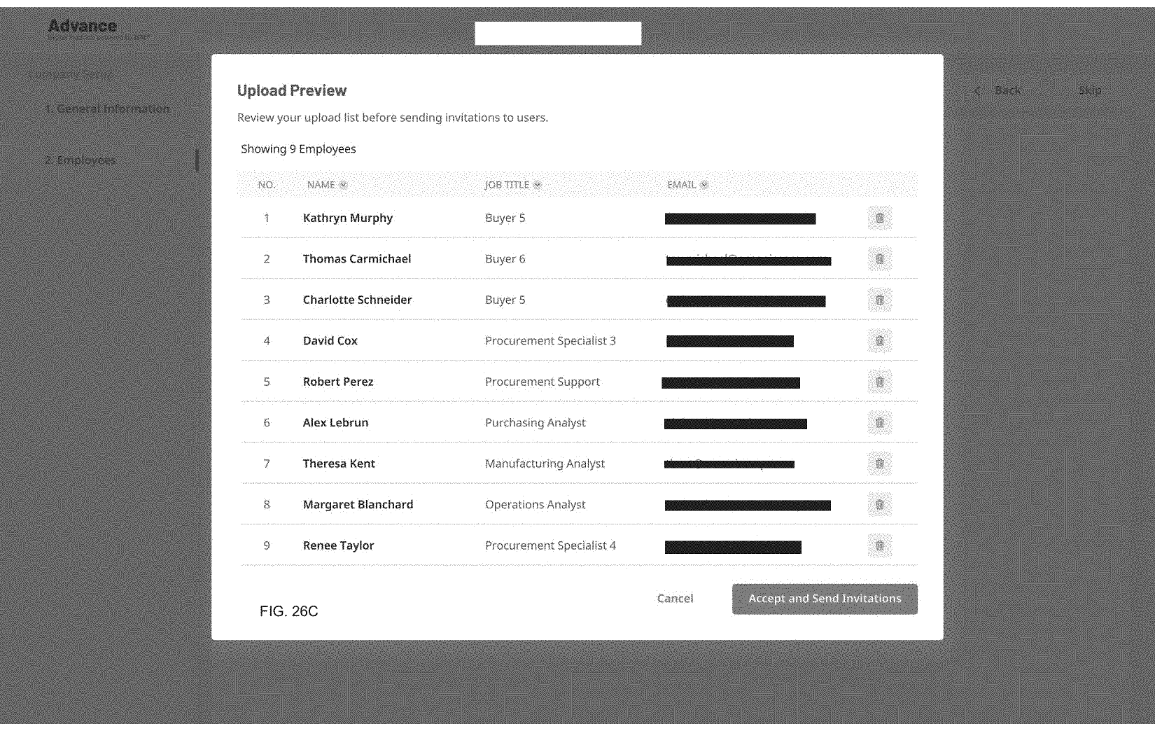

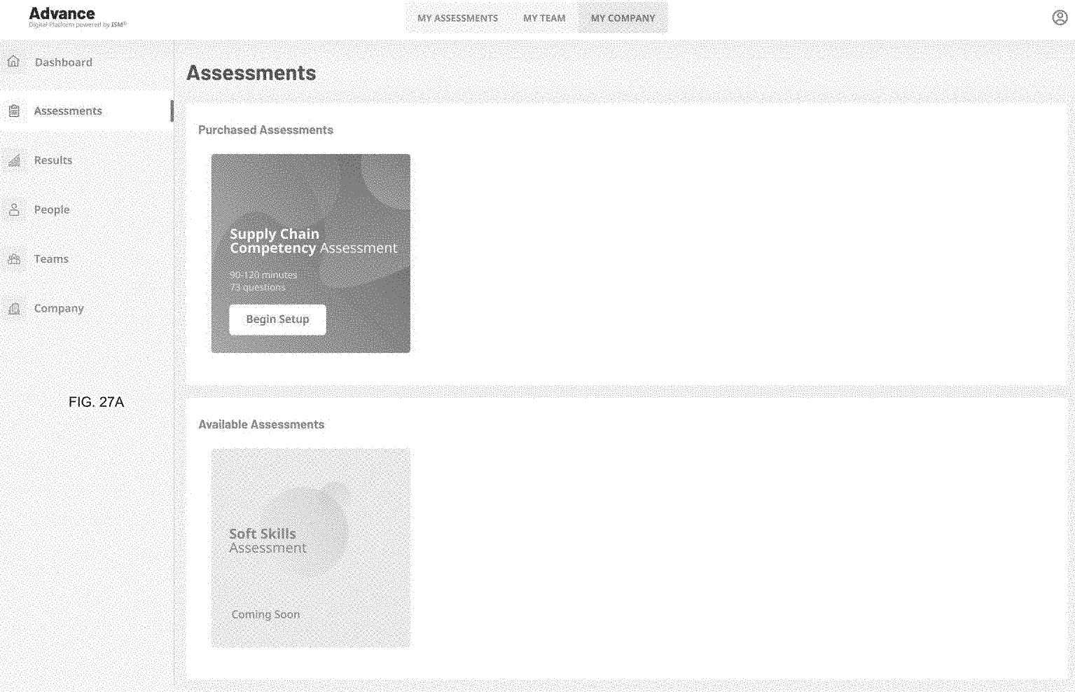

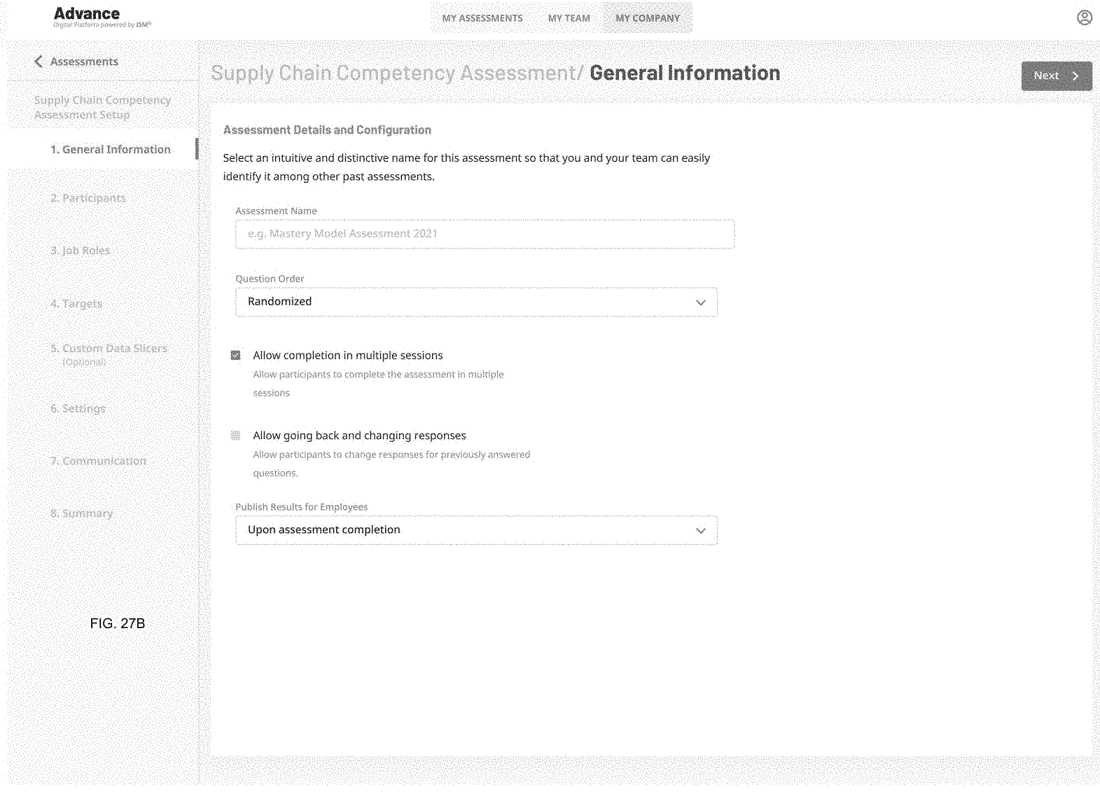

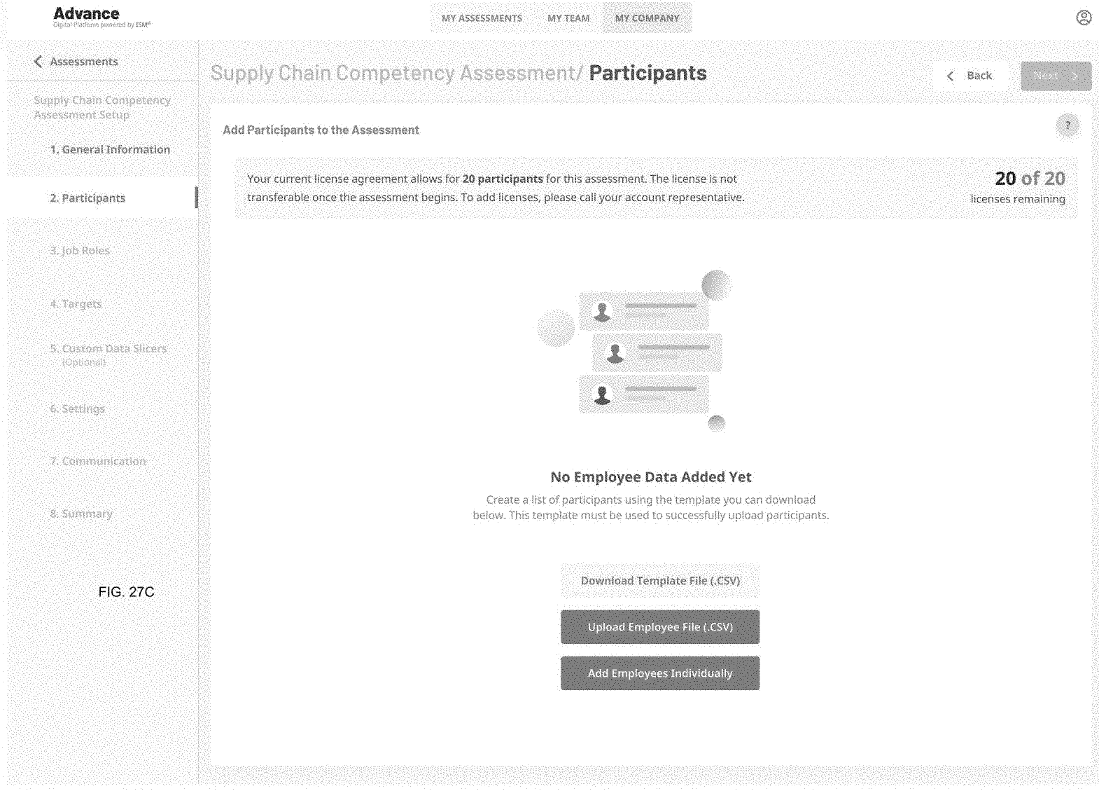

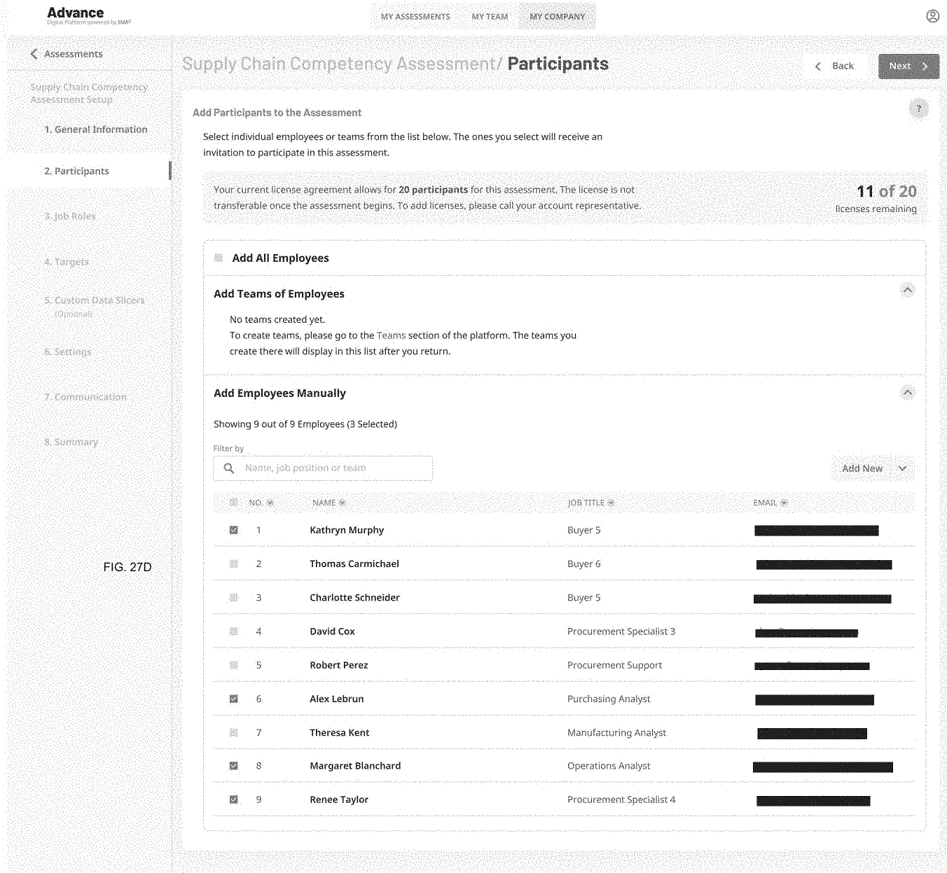

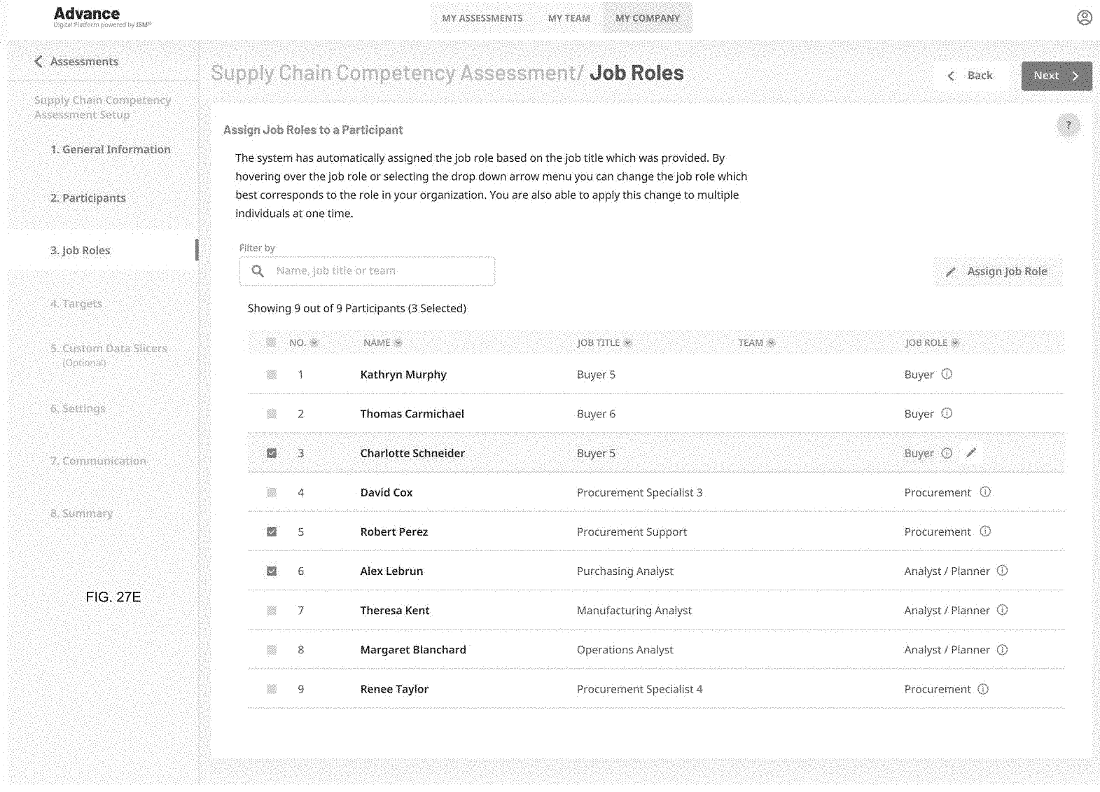

Referring now generally to FIGS. 1 and 2, an exemplary system 100 for implementing methods and apparatus for assessing talent may operate in conjunction with a server 110 with access to one or more databases 112 and connected to a communications medium 114, such as the Internet or other network. The server 110 may communicate with other computers and machines via the communications medium 114, such as company servers 116, employee work computers 118, remote personal computers 120, tablets, smartphones 122, and the like. Generally, the company servers 116, employee work computers 118, remote personal computers 120, tablets, smartphones 122, and the like may communicate with the server 110 to assess talent and other professional characteristics among various users. The other computers and machines may be used to communicate with the server 110 to utilize the system 100, such as to respond to surveys, receive assessments and other output reports, perform administrative functions, and request data analysis and reports, and may utilize any appropriate communication methods and systems.

The communications medium 114 facilitates communication between various elements of the system 100 and may comprise one or more media for electronic or other forms of communication. For example, the communications medium may comprise or utilize the Internet, intranets, local area networks, cellular communications, and any other appropriate form of communication.

The server 110 implements the functions of the methods and apparatus for talent assessment. The server 110 may comprise any suitable system for implementing the functions, such as a computer system, a distributed computing system operating on multiple machines, a virtual platform operating on one or more machines, a mainframe computing system, a computer cooperating with other computers to send and receive information, store and retrieve data, execute functions, render and receive services, and the like.

In the present exemplary embodiment, referring to the Azure Diagram, the server 110 may comprise a secure platform operating on one or more secure computer servers having access to the communications medium 114. The server 110 may also include or have access to one or more databases 112 to store and retrieve data, such as data generated and/or otherwise dedicated to the server 110, as well as external databases, such as commercial databases that provide data to third parties, databases owned or otherwise controlled by customers or other users of the system 100, and/or publicly accessible databases. The server 110 may be configured to perform or receive various functions, such as via various pods. The server 110 may be implemented and configured, however, according to any appropriate architecture and computing environment, including database architectures, data analytics capabilities, and communication/networking infrastructures.

In various embodiments, the system 100 may provide a platform for assessing and improving talent, such as within an organization or for an individual. The platform may be implemented in hardware, software, firmware, or any combination, and may be implemented in conjunction with any appropriate equipment or systems. In the present exemplary embodiment, the system 100 comprises a dedicated and secure software platform on the server 110 accessible to third parties, such as customers on a purchased, subscription, and/or licensed basis. The various capabilities and implementations of the system 100 may be scaled and adapted for different disciplines, professions, industries, and environments.

In various embodiments, the server 110 may include a machine learning system or other artificial intelligence and/or data mining system. For example, the machine learning system may include a supervised learning system, an unsupervised learning system, a reinforcement learning system, or other system that causes a computer to act without being explicitly programmed. In the present system, the machine learning system may perform multiple functions, such as capturing and creating learned benchmarks for various competencies, sub-competencies, roles, and titles. The machine learning system may also analyze and identify future skill requirements, job roles, job descriptions, and competencies, such as to surface trends using learned behavior. The scope and accuracy of the machine learning system may improve as additional data is accumulated over time, and may be implemented to accommodate additional and/or future skills or competencies, such as by additional technical and soft skill areas in talent assessments.

The server 110 may also operate on data to generate output for the system 100 according to one or more algorithms. The algorithms may provide any appropriate functions, such as to analyze future skill requirements, job roles, job descriptions, and competencies.

The server 110 may also implement other functions that may be appropriate for the system 100. For example, in the present embodiment, the server 110 may include a calendar system for providing reminders, such as to take assessment surveys, subscription renewal, status updates, team reassessments, and the like. The server 110 may provide a dashboard and pop-up reminders to users to provide any appropriate information, such as the status of an individual's assessments, team assessments, online communities, administrative information, and reminders.

In the present exemplary embodiment, methods and apparatus for assessing talent implemented in conjunction with the server 110 may comprise an assessment system comprising an assessment, software, and product suite. The assessment system may facilitate setting up profiles, such as for individuals, teams, and companies to assessing the talent of individuals and teams, and may provide assessment report using comparative data, such as benchmarking and/or prevalence data. In various embodiments, the assessment system may generate and accumulate benchmarking and/or prevalence data. The assessment system may track data indicating trends for personnel, such as role, title, competency, and sub-competency trends by profession, company, and other categories. By assessing the talent of personnel, potentially repeatedly over time, the system 100 may identify underutilized talents and other resources and associated value, rank skills for a team, and assess the impact of new team members.

The assessment system may further provide guidance for future planning and improvement. For example, the assessment system may identify new competencies, titles, and roles for future needs based on data collected and analyzed by the system 100, as well as create and inform future job descriptions, such as to fill an identified need in an organization. Talent assessments by the system may inform training decisions development plans for an individual, team, and/or company by identifying gaps in training, and may also serve as a hiring tool to evaluate candidates. The talent assessments may facilitate and inform soft skills training, covering topics such as negotiation, stakeholder engagement, leading change, and structured communications. Additional assessments and reassessments over time may facilitate data comparisons, including company and individual development and movement.

The server 110 may implement various functions and modules to achieve the various features and results of the system 100. For example, in various embodiments, the server 110 may provide a setup system for starting a talent assessment, an assessment platform for gathering assessment data from users, a reporting system for providing reports based on gathered and analyzed data, and a maintenance system for scheduling follow-up assessments and updating data and improvement strategies.

The setup system facilitates gathering and storing information to begin talent assessments, such as names, contact information, current positions, company structure and background, and the like. The setup system may gather any suitable information and store the data in any appropriate format. For example, the setup system may provide a system administrator setup module for the system 100 administrator and a client administrator setup module for the client. Each setup module may gather information from the relevant user to set up the talent assessment for a client or other user, and may facilitate cooperation and consultation between the system 100 administrator and client administrator.

For example, referring to the various figures, the system 100 administrator may access an administrator's account to interact with a system administrator's interface, such as a main dashboard. The main dashboard may offer an array of options, such as controlling products offered on the system 100, viewing and responding to alerts, creating and controlling job roles utilized by the system 100, monitoring and controlling assessments in progress or completed by the system 100, controlling analytics for output reports, viewing notifications regarding assessments and tasks, and administrative functions like controlling the system 100 administrator's account and team.

The system 100 administrator may set up a new client account, such as for a new company, team, or individual. The system 100 administrator may enter any appropriate information for the account, such as the name of the client and the name and contact information for the client administrator. The system 100 administrator may also provide information relating to talent assessment projects, such as project timelines, reporting arrangements, and calendaring milestone client meetings

The system 100 administrator setup module may contact the client administrator, such as via an email invitation, to open the client administrator setup module to provide information to support the talent assessment. The invitation may address any appropriate matters, such as providing internal communication suggestions and requesting new or future competencies, skills, roles from the client.

When the client administrator accepts the invitation, the client administrator's computer or other device may contact the system 100 and access the client administrator setup module. In various embodiments, the client administrator setup module may prompt the client administrator for information to support the talent assessment, such as client data and identifying information for employees to be assessed. The client administrator setup module may request any suitable information, such as:
Company Name
Company Size
Industry
Number of Employees to Assess
Job Descriptions
Job Titles
Role Levels
Company Functional Area
Number of Employees in Functional Areas
Company Competency Targets or Goals
Custom or Standard Competency Targets or Goals
New Skills or Competencies Added/Adjusted with Description
New Sub-Competencies Added/Adjusted with Description
Future Competencies Added with Description
Future Sub-competencies Added with Description
Organizational Goals
Administrator or Leader Contact
Reporting Manager
Employee Names
Employee Emails
Job Level Ranking
Direct or Indirect

The client administrator setup module may use information received from the client administrator to set up a profile for the client. The client administrator setup module may take additional steps, such as mapping all competencies and descriptions to job roles and arranging a timeline for assessment completion and generating automated reminders. In the present embodiment, the client administrator may select or develop a communications plan for communicating with the system administrator and client personnel, assess needs for talent development among client personnel, identify key personnel such as leaders, administrators, and team managers, and review system 100 features and select options that best fit company needs. The client administrator setup module may generate an assessment plan including personnel to be assessed, the assessments to be taken by the various personnel, timelines for completion of the assessments, and desired output reports and analyses.

The client administrator setup module may automatically invite personnel to set up accounts and profiles, including employees to be assessed, managers, and leaders. For those to be assessed, the users may provide additional personal and professional information, and may select assessment types, job roles, target scores, and skills to be developed. Additionally or alternatively, the client administrator setup module may provide some of the information, such as assessments to be completed, either automatically or in conjunction with input from the client administrator, managers, and/or leaders. In the present embodiment, targets are automatically created by the client administrator setup module and provided to the users. Job role for a single user may vary from assessment to assessment. In addition, the client administrator setup module may automatically associate a title with one or more job roles.

The information generated by the client administrator setup module and the system 100 administrator setup module may be stored in the database 112, such as in platform profiles.

After setup, the assessments may be completed by the various personnel. For example, the system 100 may send a link for an employee to access their respective profiles, which may provide links to all assessments assigned to the employee and not yet completed. The employee is required to take the assessment within a timeframe, such as in accordance with the timeline established by the client administrator setup module. If the deadline to complete an assessment is approaching, the system 100 may provide automated prompts to complete the assessment.

The assessments may be provided and completed in any appropriate manner, such as via surveys or tests conducted via computer. For example, the employee may be given questions to be answered in one or more relevant talent field, such as business intelligence. The answers provided by the user are stored by the server 110 and compared to correct answers to determine whether then answer is correct to create results, which may also be stored by the server 110.

The content of the assessments may be selected according to any suitable criteria, such as the job roles associated with the assessment and the skill levels of the respondents. The content may be selected according to any appropriate field or profession. In the present exemplary embodiment relating to supply chain management, the content may be associated with competencies such as corporate business acumen, social responsibility and ethics, leadership, business acumen, cost and price management, financial analysis, legal, logistics management, supply chain planning, and other areas of competency for supply chain management. The competencies may include sub-competencies to be tested as well. For example, competency relating to cost and price management may include subcompetencies such as cost, portfolio analysis, price, and total cost of ownership (TCO). The content may be designed to test the knowledge, logic, reasoning, experience, and/or other aspects of the user's talent in the particular competency and/or subcompetency.

In various embodiments, the assessments may include functionality for various question types, including abstract reasoning, right/wrong answers, multiple choice, scenarios, situational analysis, and simulations. The server 110 may identify patterns for all question types, and the assessment may be available under a set time limit.

When the user completes an assessment, other personnel, such as the client administrator, manager, and/or leader may be notified that the assessment is complete. Various home dashboards for different parties may be updated with notices that assessments are complete. The server 110 may automatically generate summary reports, store them in the appropriate profiles, and send them to selected personnel, such as the client leader and/or administrator. In various embodiments, a simplified summary may be provided to the employee.

The results of the user's assessment are stored by the server 110, such as in the database 112. The results may be provided to the user, the user's manager, the client leader, the client admin, the system 100 administrator, and/or any other relevant parties. In various embodiments, the system 100 administrator may manage organization permissions to determine which parties may access particular results.

Results may be represented visually to communicate the data to individuals, team leaders, administrators, and companies. For example, the following outputs may be created by the server 110 and stored within the company and respective individual profiles.
Individual Assessment Scores
   Scores by Competency
   Scores by Sub-competency
Individual Competency Gaps (plus/delta) vs Manager View
   Gap by Competency
   Gap by Sub-competency
Individual Competency Gaps (plus/delta) vs Company Target
   Gap by Competency
   Gap by Sub-competency
Individual Competency Gaps (plus/delta) vs Benchmarks
   Gap by Competency
   Gap by Sub-competency
Organizational Cumulative/Aggregate Assessment Scores
   Cumulative by Competency
   Cumulative by Sub-competency
   Cumulative by Role
   Cumulative by Job Title
   Cumulative by Functional Area
Scores Compared to Objective Right/Wrong Answers

The results may be presented in any appropriate manner, such as electronically with comparisons to the user's personalized target scores. For example, the results may be presented in a graphical form and separated according to competencies and/or subcompetencies and visually compared to the user's targets and historical scores. In the present embodiment, the parties having access may view and/or download the results.

Providing the results to various parties may allow those parties, such as the user's manager and the client administrator, to monitor the user's progress with the assessment and talent development, prepare learning plans for teams, identify skill gaps for individuals, identify skill gaps in teams, and/or analyze results in various ways (such as per organization, job role, assessment, etc.). The system 100 may also provide additional information derived from the results, such as input suggestions, learning recommendations, learning roadmaps for individuals, teams, and organizations, and corresponding presentations for presenting the information to the client. The additional information may be provided to any appropriate personnel, including the user, managers, administrators, and leaders. All of the results and information derived from the results may be stored in the database 112, such as to create an updated real-time database and repository for talent information.

The server 110 may also generate output reports, such as automatically or in response to requests and parameters provided by the system 100 administrator or the client administrator. Different reports may be generated for different parties, including the overall company, leaders, managers, and individuals. Specific sets or cuts of data may be reported, such as for historical purposes, and may be stored in the respective profiles. Access to various output features may be activated or deactivated, such as by the system 100 administrator, for example based on purchases, subscriptions, and/or licenses. In various embodiments, the reports may be provided in multiple formats to provide a clear analysis and summary of the results. Reporting may be automated and provided in a visual format to indicate the results, and gaps to noted targets, including benchmarks.

In the present embodiment, the server 110 may automate and create a roadmap for individual development and recommendations for development plans. Leaders and companies may have the ability to rank and add the level of importance of a competency based on current and future state, as well as to see gaps and an automated organizational roadmap. Companies may identify employee resources that may be under-utilized opportunities based on skills and competencies, such as in conjunction with the machine learning component of the system and leveraging the data input into profiles.

The server 110 may also compare the core competencies of a client company to new, future, and emerging competencies to assess a company and team for future transformation and preparedness. The server 110 may also provide an opportunity for companies to indicate the organizational, team or individual goals, and compare results to the noted priorities of those goals.

In various embodiments, the server 110, such as in conjunction with machine learning, may automate and create a bank of smart future job descriptions. The server 110 may also provide tools for succession planning, such as based on company workforces and skills, such as by developing a succession plan and providing a risk assessment based on team competencies to future needs. The database 112 may store data associated with employees of the client company, so that when the company creates a new job with noted requirements, the server 110 may assess the current team's competencies and skillset.

The process of setting up assessments for various competencies may be repeated as personnel receive training and develop their skills. By repeatedly performing assessments of personnel over time, the server 110 may track the development and improvement of users, teams, and companies over time and identify deficiencies, remedies, and improvements to develop talent in the organization. The users, managers, leaders, and other personnel may update the job roles, talents, competencies, assessment types, learning recommendations, learning plans, assessment plans, roadmaps, benchmarks, and targets over time, and monitor the progress of personnel, teams, and the overall organization.

In addition, the results and other data may be collected and stored in the database as an overall collection over many organizations. Historical data may be leveraged for benchmarking and prevalence data across individual and organizational assessments, as well as surveys or assessments of practice areas.

Level I: The user/company subscribes to access of benchmarking data

Exemplary features:
Unlimited access to data and all its cuts
Set number of hours of advisory time to discuss data and any results
Input to drive other data/cuts
Access to meeting with leaders of other participating organizations at roundtable event
Access to job description database (anonymized, includes future job descriptions based on software's machine learning)

Level II: The user/company subscribes to annual access of benchmarking data
Features: Unlimited access to data and all its cuts

Level III: The user/company subscribes to annual access of benchmarking data
Features: Access to set number of data cuts

Ad hoc: can purchase set cuts of data as needed on fee basis

Creates an online community (internal and external)
All users create profiles to consolidate reporting

COMPANY OUTPUTS—Benchmarking Subscription

For those who purchased Team Assessments: Report by all data “cuts” compared to benchmarks
By Competency
By Sub-Competency
By Role
By Title
By Industry
By New Competencies

Standalone Benchmarking Subscribers: Report of all data “cuts” of benchmarks (updated in real-time)
By Competency
By Sub-Competency
By Role
By Title
By Industry

Summary report of all comparisons

HIRING TOOL

For Talent/HR/Recruiters, Learning & Development leaders, companies who have completed initial set of assessments

Contingency: Hiring tool may be created over time, for example in conjunction with accumulated or otherwise acquired benchmarking data

Platform may use machine learning to present role that aligns and is recommended based on assessed skills and competencies
May present recommendation to hiring manager and/or candidate

Hiring managers upload job descriptions for open roles to platform/database
Hiring managers are taken through list of questions to assess skills/competencies to include in assessing candidates, based on role
If no job description, input required skills/competencies and (when available) recommended job description may populate based on information provided (pulled from database)

A new potential hire may create a profile, login and take the self-assessment, including right/wrong answers and abstract reasoning
Results may provide recommendation on “match” with any noted development needs, with reservations, or indicate appropriate match for position
Includes consulting discussion, with set number of hours with the hiring tool access
A summary and detailed report may be provided for the leader on the candidate's results
The candidate may receive a summary snapshot of their results

Includes access to job description database, and users acknowledge that all job descriptions added in use may be leveraged with an anonymized version to update database

In various embodiments, an assessment system may comprise an assessment, software, and product suite to be developed and launched in multiple phases.

The assessment system may implement an assessment model, including technical, functional, business, and soft skill competencies. The assessment model and its supporting framework may include an automated process, reporting, organization benchmarking of self-assessment results, as well as manager review and assessment to provide a multi-degree perspective. In addition, the assessment system may feature right and wrong answers, as well as abstract reasoning.

The assessment system may include a soft skills or “people acumen” portion with supporting training, along with leadership competencies, which may generate richer content and data outcomes for the assessment system. The soft skills assessment can be done along with the overall talent assessment or operated as a standalone system.

The assessment system may create a source of valuable talent and skills-based data that may accumulate. The assessment system may build a pool of organization, industry, and team data, which may be used for various applications, such as benchmarking and prevalence data capabilities. Reporting at such levels can provide deeper content to enhance and inform other related product areas (education, certification, research, etc.).

The assessment system may also perform and store organizational assessments, which can connect to the individual competency assessment data and results at a company level. Organizational assessments may include a gauge on maturity across multiple areas of expertise. For example, organizations may dive deeper into their collective maturity and expertise in data and analytics, sustainability, strategic sourcing, and supplier relationship management in the supply management field. Each area may have complementary individual assessments in future phases.

In an exemplary application, the methods and apparatus according to various aspects of the present invention are implemented in the field of procurement and supply management. The role of procurement and supply management within organizations has evolved rapidly in recent decades, and practitioners need to be increasingly strategic. While historically a function that focused on purchasing, it now encompasses broader supply management disciplines that are critical to business success. Procurement is a value-driver for organizations. The present technology may facilitate supply chain teams and individuals taking a skill-based self-assessment and/or multi-degree assessment and benchmarking technical, business, and soft skills.

An assessment system according to various aspects of the present technology may be configured to support the supply management environment. For example, the system may be adapted to include professional standards based on prevalence data and assessments, which may be applicable to related fields. For example, the assessment system may be effective in the talent space, such as to craft a hiring assessment tool and related offerings for supply chain (and other industry and profession) leaders to build and train high-performing teams in an informed, data-driven way. Individual and organizational data may ensure companies can create a clear path forward for their teams and respective areas of expertise (supply management, HR, etc.).

Applications

In one embodiment, the assessment system may be adapted for the supply management, procurement, and supply chain fields. For example, leaders of corporations with moderately mature organizations, and annual revenue of more than US$500 million may utilize the system, but the assessment system may serve smaller-to-mid-size organizations as well, or even individual users. Various embodiments may be adapted to other disciplines and expertise within the profession, and across industry sectors.

Other areas may also benefit from the assessment system's data. For example, human resources, talent management, recruiting, and CHROs may leverage the data for hiring decisions and assessments. The assessment system may find application in many other areas (sales, marketing, product, etc.).

The assessment system may include elements such as platform structure, assessment capabilities, data uses, benchmarking, machine learning, job matching, development plans, and reporting, as well as the contents of the assessments themselves.

The assessment system may facilitate:
Talent assessment for an industry or area of practice for existing employees, along with new hire matching.
Data generated by the assessment system and the tools for sorting and reviewing it.
A database of professionals and the ability to match them with a job recommendation for the employer or for contingent workers. The database may include the community of practitioners by profession and industry, with the unique data of their actual skills based on the assessment, as opposed to the person self-selecting.
Data for various professions, industries, competencies, roles, job descriptions and assessments may be included in one database or a limited set of databases, and tools may be provided to leverage that data and report on it. This data and tools may function by profession.

In one embodiment, the assessment system may be integrated into a dedicated software platform, with a featured algorithm and machine learning. Features can be set to turn on and off, for example based on purchases, licenses, and/or subscriptions.

In one embodiment, the assessment system analyzes future skill requirements, job roles, job descriptions, and competencies to surface trends using learned behavior. Users can add additional and/or future skills or competencies to the assessment in technical and soft skill areas.

Platform access may be controlled, such as on a subscription basis. Over time, the platform's machine learning captures and creates learned benchmarks for competencies, sub-competencies, roles, and titles. This may include future roles and added competencies provided by any participating companies.

Reporting outputs may be noted for companies, leaders, and individuals, which may be housed in the platform profiles that users are prompted to create and update. Results may be stored, and specific sets or cuts of data purchased for historical purposes may be housed in the respective profiles, such as for the duration of annual subscriptions or otherwise. Historical data may be leveraged for benchmarking and prevalence data across individual and organizational assessments, as well as surveys or assessments of practice areas.

The reports may be in multiple formats to provide a clear analysis and summary of the results. Report generation may be automated and provided in a visual format to indicate the results, and gaps to relevant targets, including benchmarks.

The platform may include capabilities for pop-up reminders, status updates, a dashboard with an overview of assessment status for a team, and profile administrative information. When an organization is nearing the end of a subscription, reminders may be prompted to renew and reassess a team.

The platform may also automate and create a roadmap for individual development and recommendations for development plans. Leaders and companies may rank and adjust the importance of a competency based on current and future state, to see gaps and an automated organizational roadmap. Using machine learning and leveraging the data input into profiles, companies can see employee resources that could be under-utilized, and indicate opportunities based on skills and competencies.

The platform may compare the core competencies to new, future, and emerging competencies to assess a company and team for future transformation and preparedness. The platform may also provide an opportunity for companies to indicate the organizational, team or individual goals, and compare results to the noted priorities of those goals. This may be available to selected company team members, including a contingent workforce.

Over time, the assessment system may create job descriptions and facilitate succession planning based on company workforces and skills. The assessment system may facilitate building out a succession plan and provide a risk assessment based on team competencies to future needs. The assessment system may include database functionality to store employees with the associated company, so that when the company creates a new job with noted requirements, the platform may assess the current team's competencies and skillset. This may be useful for ongoing engagement and for users to keep profiles current, particularly with reassessments.

The assessments themselves may include functionality for various question types, including abstract reasoning, right/wrong answers, multiple choice, scenarios, situational analysis, and simulations. The platform may identify patterns for all question types, and assessments may be performed under a set time limit.

The assessment system, including structure of the software platform, may be adapted to any suitable data, product design, application, and capabilities requirements. Specific areas of differentiation from other systems may include:
Differentiated benchmarking, prevalence, and profession data, with various ways to sort it
Comprehensive competency assessment for current and future needs
Assessment that automates future job descriptions
Trend/aggregate view of key functional business area in global economy, noting changes, health, and transformations companies are making as roles/competencies evolve
Company development investment recommendations provided by machine learning
Dedicated community of professionals and organizations invested in professional development and learning
Recommended learning, development paths and organizational initiatives and/or operating models to pursue to achieve organizational goals based on combined inputs of organizational, practice area and individual assessments
Predictive and prescriptive analytics based on combined platform data

In addition, the talent assessment for a given industry or area of practice for existing employees as well as the new hire match, are both unique. The new hire match and functionality could support any profession. The following are other unique elements and features.

The database of professionals and the ability to match them with a job, recommendation for the employer or for contingent workers. The community of practitioners by profession and industry, with the unique data of their actual skills based on the assessment, as opposed to the person self-selecting, is a differentiator.

The database of various professions, industries, competencies, roles, job descriptions and assessments in one database is a very big deal and the ability to leverage that data and report on it. This functionality by profession would be of interest to our competitors. This functionality overall to have a complete database of all professions and the features described is unique.

The assessment system may offer talent assessment for a given industry or area of practice for existing employees as well as new hire matches. The new hire match functionality may be applied to any profession. The following are other elements and features.
The database of professionals and the ability to match them with a job, recommendation for the employer or for contingent workers. The community of practitioners by profession and industry, with the unique data of their actual skills based on the assessment, as opposed to the person self-selecting, is a differentiator.
The present technology may include a database of various professions, industries, competencies, roles, job descriptions and assessments, such as in a single database, which may be used for analysis and reporting and the ability to leverage that data and report on it. This functionality by profession would be of interest to our competitors. This functionality overall to have a complete database of all professions and the features described is unique. p In various embodiments, the system 100 may be implemented as follows:

Phase I

Team/Individual/Manager Assessments & Platform—Process Flow

The following are in part, automated steps and processes through the platform, along with support provided by super administrator platform role and company administrator.

STEP 1: Company Provides Input Data

System 100 administrator confirmation to client with internal communication suggestions (default that can be updated by company administrator role)

System 100 administrator provides timeline for entire project (automated, but can be adjusted)

System 100 administrator sets up reporting and all milestone client meetings (automated)

Gather any new/future competencies, skills, roles from company

Client administrator role updates platform profile created and setup by super administrator

STEP 2: Platform Setup

Client administrator adds/uploads employees to the platform to assess

Any new/future competencies with descriptions/details added to system

Based on assessment type, system maps all competencies and descriptions to job roles (automated and/or can be selected my client administrator)

Input company targets and goals or can leverage default/benchmark target

Set timeline for assessment completion with automated reminders (default timeline by system)

STEP 3: Employee Assessment on Platform

System provides invitation and link for company employees to create profile login to begin assessment

Employee takes assessment within provided client timeframe

If not done in timely manner, automated communication prompts to complete

STEP 4: Assessment Reporting

Administrator and leader notified that assessments complete

Home dashboard updated with notice that assessments complete

Multiple dashboards available based on user role and permissions (i.e.

individual for their own results, manager to see a team's results, leader can see organizational, etc.)

Summary reports automatically generated by system and available in dashboard and results views, detailed cuts of data are also available

All data from assessment sets stored within platform solution architecture

Company Inputs/Selections—Assessment Platform

The following are data inputs or selections that will be asked of the participating companies, with asterisks (*) indicating required inputs or selected fields.
Company Name*
Company Size
Industry*
Number of Employees to Assess*
Job Descriptions
Job Titles*
Job Roles*
Job Level
Company Functional Area or Team
Number of Employees in Functional Areas or Teams
Company Competency Targets* (custom available)
Use of Benchmark and Standards Targets* (selection)
New Skills or Competencies Added/Adjusted with Description
New Sub-Competencies Added/Adjusted with Description
Future Competencies Added with Description
Future Sub-competencies Added with Description—Organizational

Goals
Administrator or Leader Contact*
Reporting Manager
Employee Names*
Employee Emails*
Direct or Indirect
Manufacturing or Services Industry (mapped based on NAICS code)

COMPANY OUTPUTS—Team/Individual/Organizational Assessments

Reporting will be represented visually to communicate the data to individuals, team leaders, administrators and company clients. The following represents specific outputs that will be created by the assessment platform and suite and housed within the organization and respective individual profiles. Custom data slicers are available based on provided selections and data inputs.

Individual Assessment Scores

Scores by Competency

Scores by Sub-competency

Individual Competency Gaps (plus/delta) vs Manager View

Gap by Competency

Gap by Sub-competency

Individual Competency Gaps (plus/delta) vs Company Target

Gap by Competency

Gap by Sub-competency

Individual Competency Gaps (plus/delta) vs Benchmarks or Standards

Gap by Competency

Gap by Sub-competency

Organizational Cumulative/Aggregate Assessment Scores

Cumulative by Competency

Cumulative by Sub-competency

Cumulative by Role

Cumulative by Job Title

Cumulative by Functional Area or Team

Scores Compared to Objective Right/Wrong Answers

Phase II

BENCHMARKING SUBSCRIPTION OR LICENSE MODEL

Level I: The user/company subscribes to annual access of benchmarking data and assessment platform

Features:

Unlimited access to data and all its cuts

Set number of hours of advisory time to discuss data and any results

Input to drive other data/cuts

Access to meeting with leaders of other participating organizations at roundtable event

Access to job description database (anonymized, includes future job descriptions based on software's machine learning)

Highest price point

Level II: The user/company subscribes to annual access of benchmarking data

Features: Unlimited access to data and all its cuts

Level III: The user/company subscribes to annual access of benchmarking data

Features: Access to set number of data cuts

Ad hoc: can purchase set cuts of data as needed on fee basis

Creates an online community (internal and external)

All users create profiles to consolidate reporting

COMPANY OUTPUTS—Benchmarking or Prevalence Subscription

For those who purchased Team Assessments: Report by all data “cuts” compared to benchmarks

By Competency

By Sub-Competency

By Role

By Title

By Industry

By New Competencies

Standalone Benchmarking Subscribers: Report of all data “cuts” of benchmarks (updated in real-time)

By Competency

By Sub-Competency

By Role

By Title

By Industry

Summary report of all comparisons

Phase III

HIRING TOOL

Audiences: Talent/HR/Recruiters, Learning & Development leaders, companies who have completed initial set of assessments

Contingency: Hiring tool is next phase, to be created over time, once benchmarking data is amassed and is significant

Platform uses machine learning to present role that aligns and is recommended based on assessed skills and competencies

Presents recommendation to hiring manager and candidate

Hiring managers upload job descriptions for open roles to platform/database

Hiring managers are taken through list of questions to assess skills/competencies to include in assessing candidates, based on role

If no job description, input required skills/competencies and (when available) recommended job description will populate based on information provided (pulled from database)

A new potential hire will create a profile, login and take the self-assessment, including right/wrong answers and abstract reasoning

Results will provide recommendation on “match” with any noted development needs, with reservations, or indicate appropriate match for position

Includes consulting discussion, with set number of hours with the hiring tool access

A summary and detailed report will be provided for the leader on the candidate's results

The candidate will receive a summary snapshot of their results

Includes access to job description database, and users acknowledge that all job descriptions added in use will be leveraged with an anonymized version to update database

OVERALL PRODUCT SUITE AND PLATFORM OUTCOMES

Below is a simplified view of overall outcomes for this innovation and product suite.

Benchmarking/prevalence data over time

Role, title, competency and sub-competency trends by profession

New competencies, titles, roles that emerge for future needs

Ability to create and inform future job descriptions

Capabilities and software/platform for other disciplines to use as licensing model in a future phase

Hiring assessment (also offered as standalone)

Online community

Informs training decisions for companies

Creates development plans and roadmaps for individuals, functions and organizations

Career pathing

Subscription and license model for data

Surfaces underutilized internal resources (and value that provides to comp any)

Reassessment and data comparisons, including company and individual development and movement

Can assess impact of new team members in reassessment comparison

Creates updated real-time database/repository

Provides ranking of skills for a team

In the foregoing specification, the invention has been described with reference to specific exemplary embodiments. Various modifications and changes may be made, however, without departing from the scope of the present invention. The specification and figures are illustrative, not restrictive, and modifications are intended to be included within the scope of the present invention. Accordingly, the scope of the invention should be determined by any resulting claims and their legal equivalents rather than by merely the examples described.

For example, the steps recited in any method or process may be executed in any order and are not limited to the specific order presented. Additionally, the components and/or elements recited for any apparatus may be assembled or otherwise operationally configured in a variety of permutations and are accordingly not limited to the specific configuration described.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The terms “comprise”, “comprises”, “comprising”, “having”, “including”, “includes” or any variations of such terms, are intended to reference a non-exclusive inclusion, such that a process, method, article, composition, or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

1. A system as described herein.
